(19) United States
(12) Patent Application Publication
(10) Pub. No.: US 2025/0293713 A1
(43) Pub. Date: Sep. 18, 2025

(54) DIGITIZER FOR GROUND STATIONS AND REMOTE TERMINALS

(71) Applicant: Kratos Integral Holdings LLC, San Diego, CA (US)

(72) Inventors: Stuart Daughtridge, Huntingtown, MD (US); Kevin Tobias, Aldie, VA (US)

(21) Appl. No.: 19/081,783

(22) Filed: Mar. 17, 2025

Related U.S. Application Data
(60) Provisional application No. 63/566,542, filed on Mar. 18, 2024.

(51) Int. Cl. H04B 1/00

(52) U.S. Cl. CPC H04B 1/0007; H04B 1/0078

(57) ABSTRACT

Described herein is a digitizer for use at a ground station or a remote terminal of a satellite communication system. The digitizer includes a radio interface having a DAC for converting an outbound digital waveform into an outbound analog signal and an ADC for converting an inbound analog signal into an inbound digital waveform. The digitizer also includes a configurable logic device coupled with the radio interface. The configurable logic device is configured to generate first and second streams of digital IF packets containing portions of the inbound digital waveform within first and second frequency bands. The configurable logic device is also configured to send the first and second streams of digital IF packets to first and second VNFs for processing in accordance with first and second applications.

### CROSS-REFERENCES TO RELATED APPLICATIONS

This application claims the benefit of priority to U.S. Provisional Patent Application No. 63/566,542, filed Mar. 18, 2024, entitled “DIGITIZER FOR GROUND STATIONS AND REMOTE TERMINALS WITH TIMING AND FREQUENCY SYNCHRONIZATION,” the entire content of which is incorporated herein by reference for all purposes.

### BACKGROUND OF THE INVENTION

Satellite communication systems play a crucial role in facilitating global connectivity across diverse applications, including telecommunications, broadcasting, internet services, and remote sensing. These systems operate by transmitting signals between ground-based Earth stations and satellites in orbit. The efficiency and reliability of such systems are important to addressing the increasing demands of contemporary communication and data services. Presently, communications engineers encounter numerous challenges, with a key concern being the optimization of information transmission over limited resources. Given the scarcity of available frequencies for radio signal communication and the rapid growth in the volume of information to be conveyed, there is a need to maximize the efficiency of available frequencies through the use of new hardware and software solutions at the ground stations, terminals, and satellites that make up such communication systems.

### SUMMARY OF THE INVENTION

A summary of the various embodiments of the invention is provided below as a list of examples. As used below, any reference to a series of examples is to be understood as a reference to each of those examples disjunctively (e.g., “Examples 1-4” is to be understood as “Examples 1, 2, 3, or 4”).

Example 1 is an apparatus comprising: a radio interface comprising a digital-to-analog converter (DAC) for converting an outbound digital waveform into an outbound analog signal and an analog-to-digital converter (ADC) for converting an inbound analog signal into an inbound digital waveform; and a configurable logic device coupled with the radio interface, the configurable logic device configured to: respectively send and receive the outbound digital waveform and the inbound digital waveform to and from the radio interface; generate a first stream of digital IF packets containing portions of the inbound digital waveform within a first frequency band; generate a second stream of digital IF packets containing portions of the inbound digital waveform within a second frequency band; send the first stream of digital IF packets to a first virtual network function (VNF) for processing in accordance with a first application; and send the second stream of digital IF packets to a second VNF for processing in accordance with a second application.

Example 2 is the apparatus of example(s) 1, wherein the second stream of digital IF packets is sent concurrently with the first stream of digital IF packets.

Example 3 is the apparatus of example(s) 1, wherein the configurable logic device is a field-programmable gate array (FPGA).

Example 4 is the apparatus of example(s) 1, further comprising: an input port for receiving the inbound analog signal; and an output port for sending the outbound analog signal.

Example 5 is the apparatus of example(s) 1, wherein the configurable logic device is further configured to: be configured in accordance with a configuration file generated by a management system, wherein the configuration file indicates the first frequency band and the second frequency band.

Example 6 is the apparatus of example(s) 1, wherein the first stream of digital IF packets and the second stream of digital IF packets are sent to one or more compute nodes on which the first VNF and the second VNF are run.

Example 7 is the apparatus of example(s) 6, wherein the first stream of digital IF packets and the second stream of digital IF packets are sent to the one or more compute nodes via a Peripheral Component Interconnect Express (PCIe) bus.

Example 8 is the apparatus of example(s) 1, wherein the first application of the first VNF is a satellite communications application or an Earth orbit (EO) mission download application.

Example 9 is the apparatus of example(s) 8, wherein the second application of the second VNF is a radio-frequency (RF) monitoring application, and wherein the second frequency band encompasses the first frequency band.

Example 10 is the apparatus of example(s) 9, wherein the second application is configured to, in response to determining that there is excessive RF interference in the first frequency band, generate a command to move the first frequency band to a new set of frequencies.

Example 11 is a method comprising: receiving an inbound analog signal at an apparatus; converting, by a radio interface of the apparatus, the inbound analog signal into an inbound digital waveform; generating, by a configurable logic device of the apparatus, a first stream of digital IF packets containing portions of the inbound digital waveform within a first frequency band; generating, by the configurable logic device, a second stream of digital IF packets containing portions of the inbound digital waveform within a second frequency band; sending, by the configurable logic device, the first stream of digital IF packets to a first virtual network function (VNF) for processing in accordance with a first application; and sending, by the configurable logic device, the second stream of digital IF packets to a second VNF for processing in accordance with a second application.

Example 12 is the method of example(s) 11, wherein the second stream of digital IF packets is sent concurrently with the first stream of digital IF packets.

Example 13 is the method of example(s) 11, wherein the configurable logic device is a field-programmable gate array (FPGA).

Example 14 is the method of example(s) 11, wherein the first stream of digital IF packets and the second stream of digital IF packets are sent to one or more compute nodes on which the first VNF and the second VNF are run.

Example 15 is the method of example(s) 14, wherein the first stream of digital IF packets and the second stream of digital IF packets are sent to the one or more compute nodes via a Peripheral Component Interconnect Express (PCIe) bus.

Example 16 is the method of example(s) 11, wherein the first application of the first VNF is a satellite communications application or an Earth orbit (EO) mission download application.

Example 17 is the method of example(s) 16, wherein the second application of the second VNF is a radio-frequency (RF) monitoring application, and wherein the second frequency band encompasses the first frequency band.

Example 18 is the method of example(s) 17, wherein the second application is configured to, in response to determining that there is excessive RF interference in the first frequency band, generate a command to move the first frequency band to a new set of frequencies.

Example 19 is a non-transitory computer-readable medium comprising instructions that, when executed by one or more processors, cause the one or more processors to perform operations for operating a digitizer, the operations comprising: receiving an inbound digital waveform at a configurable logic device of the digitizer, the inbound digital waveform having been converted from an inbound analog signal by a radio interface of the digitizer; generating, by the configurable logic device, a first stream of digital IF packets containing portions of the inbound digital waveform within a first frequency band; generating, by the configurable logic device, a second stream of digital IF packets containing portions of the inbound digital waveform within a second frequency band; sending, by the configurable logic device, the first stream of digital IF packets to a first virtual network function (VNF) for processing in accordance with a first application; and sending, by the configurable logic device, the second stream of digital IF packets to a second VNF for processing in accordance with a second application.

Example 20 is the non-transitory computer-readable medium of example(s) 19, wherein the second stream of digital IF packets is sent concurrently with the first stream of digital IF packets.

Example 21 is a method of performing timing and frequency synchronization at a digitizer, the method comprising: receiving a reference input at a reference port of the digitizer, the reference input being a pulse-per-second (PPS) signal or a global navigation satellite system (GNSS) signal from which the PPS signal is derived; comparing the PPS signal to a clock signal generated by a digitally controlled oscillator (DCO); controlling the DCO to lock a frequency of the clock signal to a multiple of a frequency of the PPS signal; and generating sub-second timing data using the PPS signal and the clock signal, the PPS signal being used to compute a seconds component of the sub-second timing data and the clock signal being used to compute a sub-second component of the sub-second timing data.

Example 22 is the method of example(s) 21, further comprising: controlling one or more digital circuits of the digitizer using the clock signal.

Example 23 is the method of example(s) 22, wherein controlling the one or more digital circuits of the digitizer using the clock signal includes providing the clock signal to an analog-to-digital converter (ADC) of the digitizer to control a sampling rate of the ADC.

Example 24 is the method of example(s) 21, further comprising: generating one or more timestamps at the digitizer using the sub-second timing data.

Example 25 is the method of example(s) 24, further comprising: receiving an inbound analog signal at the digitizer; converting, by a radio interface of the digitizer, the inbound analog signal into an inbound digital waveform; and generating, by a configurable logic device of the digitizer, a digital IF packet containing the inbound digital waveform, wherein the digital IF packet is generated to include the one or more timestamps.

Example 26 is the method of example(s) 21, wherein the reference input received at the reference port is the GNSS signal, and wherein the method further comprises: extracting, by a GNSS receiver of the digitizer, the PPS signal from the GNSS signal.

Example 27 is the method of example(s) 21, wherein the digitizer is a three-port device having an input port for receiving inbound analog signals, an output port for transmitting outbound analog signals, and the reference port for receiving the reference input.

Example 28 is a non-transitory computer-readable medium comprising instructions that, when executed by one or more processors, cause the one or more processors to perform operations for performing timing and frequency synchronization at a digitizer, the operations comprising: receiving a reference input at a reference port of the digitizer, the reference input being a pulse-per-second (PPS) signal or a global navigation satellite system (GNSS) signal from which the PPS signal is derived; comparing the PPS signal to a clock signal generated by a digitally controlled oscillator (DCO); controlling the DCO to lock a frequency of the clock signal to a multiple of a frequency of the PPS signal; and generating sub-second timing data using the PPS signal and the clock signal, the PPS signal being used to compute a seconds component of the sub-second timing data and the clock signal being used to compute a sub-second component of the sub-second timing data.

Example 29 is the non-transitory computer-readable medium of example(s) 28, wherein the operations further comprise: controlling one or more digital circuits of the digitizer using the clock signal.

Example 30 is the non-transitory computer-readable medium of example(s) 29, wherein controlling the one or more digital circuits of the digitizer using the clock signal includes providing the clock signal to an analog-to-digital converter (ADC) of the digitizer to control a sampling rate of the ADC.

Example 31 is the non-transitory computer-readable medium of example(s) 28, wherein the operations further comprise: generating one or more timestamps at the digitizer using the sub-second timing data.

Example 32 is the non-transitory computer-readable medium of example(s) 31, wherein the operations further comprise: receiving an inbound analog signal at the digitizer; converting, by a radio interface of the digitizer, the inbound analog signal into an inbound digital waveform; and generating, by a configurable logic device of the digitizer, a digital IF packet containing the inbound digital waveform, wherein the digital IF packet is generated to include the one or more timestamps.

Example 33 is the non-transitory computer-readable medium of example(s) 28, wherein the reference input received at the reference port is the GNSS signal, and wherein the operations further comprise: extracting, by a GNSS receiver of the digitizer, the PPS signal from the GNSS signal.

Example 34 is the non-transitory computer-readable medium of example(s) 28, wherein the digitizer is a three-port device having an input port for receiving inbound analog signals, an output port for transmitting outbound analog signals, and the reference port for receiving the reference input.

Example 35 is an apparatus comprising: a radio interface comprising a digital-to-analog converter (DAC) for converting an outbound digital waveform into an outbound analog signal and an analog-to-digital converter (ADC) for converting an inbound analog signal into an inbound digital waveform; and a reference port for receiving a reference input, the reference input being a pulse-per-second (PPS) signal or a global navigation satellite system (GNSS) signal from which the PPS signal is derived; and a digitally controlled oscillator (DCO) configured to generate a clock signal; wherein the apparatus is configured to: compare the PPS signal to the clock signal; control the DCO to lock a frequency of the clock signal to a multiple of a frequency of the PPS signal; and generate sub-second timing data using the PPS signal and the clock signal, the PPS signal being used to compute a seconds component of the sub-second timing data and the clock signal being used to compute a sub-second component of the sub-second timing data.

Example 36 is the apparatus of example(s) 35, further comprising: an input port for receiving the inbound analog signal; and an output port for transmitting the outbound analog signal.

Example 37 is the apparatus of example(s) 35, wherein the apparatus is configured to control one or more digital circuits of the apparatus using the clock signal.

Example 38 is the apparatus of example(s) 37, wherein controlling the one or more digital circuits of the apparatus using the clock signal includes providing the clock signal to the ADC to control a sampling rate of the ADC.

Example 39 is the apparatus of example(s) 35, wherein the apparatus is configured to generate one or more timestamps at the apparatus using the sub-second timing data.

Example 40 is the apparatus of example(s) 35, further comprising: a GNSS receiver configured to receive the reference input and extract the PPS signal from the GNSS signal.

Example 41 is a method of accessing a non-terrestrial network, the method comprising: receiving a network access challenge at one or more compute nodes of a terminal, the one or more compute nodes running one or more virtual network function (VNFs); sending the network access challenge from the one or more compute nodes to a digitizer of the terminal, the digitizer including a Subscriber Identity Module (SIM) card; generating, at the digitizer, SIM data based on the network access challenge and data stored in the SIM card, the SIM data including an authentication response to the network access challenge; sending the SIM data from the digitizer to the one more compute nodes; generating, at the one or more compute nodes, a digital IF packet containing the SIM data; and sending the digital IF packet from the one more compute nodes to the digitizer for wireless transmission of the SIM data to a satellite associated with the non-terrestrial network.

Example 42 is the method of example(s) 41, further comprising: prior to receiving the network access challenge, sending a network access request from the one or more compute nodes to the digitizer for wireless transmission to the satellite associated with the non-terrestrial network.

Example 43 is the method of example(s) 42, further comprising: prior to sending the network access request, obtaining network access information at the one or more compute nodes.

Example 44 is the method of example(s) 41, further comprising: inserting the SIM data into a baseband frame; and modulating the baseband frame to produce a modulated baseband frame, wherein the digital IF packet contains the modulated baseband frame.

Example 45 is the method of example(s) 41, wherein the SIM data further includes an identifier for the terminal, the identifier being one of a Subscription Permanent Identifier (SUPI) or a Subscription Concealed Identifier (SUCI).

Example 46 is the method of example(s) 41, wherein the SIM data is generated by a microprocessor of the SIM card.

Example 47 is the method of example(s) 41, wherein the digitizer further includes a radio interface comprising a digital-to-analog converter (DAC) for converting an outbound digital waveform into an outbound analog signal and an analog-to-digital converter (ADC) for converting an inbound analog signal into an inbound digital waveform.

Example 48 is the method of example(s) 41, wherein SIM card is an embedded SIM (eSIM).

Example 49 is an apparatus comprising: one or more compute nodes running one or more virtual network function (VNFs); a digitizer coupled to the one or more compute nodes, the digitizer comprising a Subscriber Identity Module (SIM) card; and an antenna coupled to the digitizer; wherein the apparatus is configured to: receive a network access challenge at the one or more compute nodes; send the network access challenge from the one or more compute nodes to the digitizer; generate, at the digitizer, SIM data based on the network access challenge and data stored in the SIM card, the SIM data including an authentication response to the network access challenge; send the SIM data from the digitizer to the one more compute nodes; generate, at the one or more compute nodes, a digital IF packet containing the SIM data; and send the digital IF packet from the one more compute nodes to the digitizer for wireless transmission of the SIM data via the antenna to a satellite associated with a non-terrestrial network.

Example 50 is the apparatus of example(s) 49, wherein the apparatus is configured to: prior to receiving the network access challenge, send a network access request from the one or more compute nodes to the digitizer for wireless transmission via the antenna to the satellite associated with the non-terrestrial network.

Example 51 is the apparatus of example(s) 50, wherein the apparatus is configured to: prior to sending the network access request, obtain network access information at the one or more compute nodes.

Example 52 is the apparatus of example(s) 49, wherein the apparatus is configured to: insert the SIM data into a baseband frame; and modulate the baseband frame to produce a modulated baseband frame, wherein the digital IF packet contains the modulated baseband frame.

Example 53 is the apparatus of example(s) 49, wherein the SIM data further includes an identifier for the apparatus, the identifier being one of a Subscription Permanent Identifier (SUPI) or a Subscription Concealed Identifier (SUCI).

Example 54 is the apparatus of example(s) 49, wherein the SIM data is generated by a microprocessor of the SIM card.

Example 55 is the apparatus of example(s) 49, wherein the digitizer further includes a radio interface comprising a digital-to-analog converter (DAC) for converting an outbound digital waveform into an outbound analog signal and an analog-to-digital converter (ADC) for converting an inbound analog signal into an inbound digital waveform.

Example 56 is the apparatus of example(s) 49, wherein SIM card is an embedded SIM (eSIM).

Example 57 is a non-transitory computer-readable medium comprising instructions that, when executed by one or more processors of one or more compute nodes of a terminal, cause the one or more processors to perform operations comprising: receiving a network access challenge from a satellite associated with a non-terrestrial network; sending the network access challenge to a digitizer of the terminal, the digitizer including a Subscriber Identity Module (SIM) card; receiving SIM data from the digitizer, the SIM data having been generated at the digitizer based on the network access challenge and data stored in the SIM card, the SIM data including an authentication response to the network access challenge; generating a digital IF packet containing the SIM data; and sending the digital IF packet to the digitizer for wireless transmission of the SIM data to the satellite associated with the non-terrestrial network.

Example 58 is the non-transitory computer-readable medium of example(s) 57, wherein the operations further comprise: prior to receiving the network access challenge, sending a network access request to the digitizer for wireless transmission to the satellite associated with the non-terrestrial network.

Example 59 is the non-transitory computer-readable medium of example(s) 58, wherein the operations further comprise: prior to sending the network access request, obtaining network access information.

Example 60 is the non-transitory computer-readable medium of example(s) 57, wherein the operations further comprise: inserting the SIM data into a baseband frame; and modulating the baseband frame to produce a modulated baseband frame, wherein the digital IF packet contains the modulated baseband frame.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and various ways in which it may be practiced.

FIG. 1 illustrates an example architecture of a digitizer deployed within a ground station or a remote terminal of a satellite communication system.

FIG. 2 illustrates an example architecture of a configurable logic device of a digitizer.

FIG. 3 illustrates an example satellite communication system including a set of gateways and a terminal.

FIG. 4 illustrates an example communication path between end points enabled by a satellite communication system.

FIG. 5 illustrates an example satellite communication system including a gateway and a set of terminals.

FIG. 6 illustrates an example digital IF packet with multiple protocol layers.

FIGS. 7A-7C illustrate example traffic adapters implementing different network types.

FIGS. 8A-8C illustrate example configurations of a terminal having a digitizer, a compute node, and an antenna.

FIGS. 9A-9C illustrate example steps for accessing a non-terrestrial network, performed at a digitizer and compute nodes of a communication unit such as a remote terminal or ground station.

FIG. 10 illustrates an example network authentication process for a communication unit to access a non-terrestrial network.

FIG. 11 illustrates a method of operating a digitizer.

FIG. 12 illustrates a method of performing timing and frequency synchronization at a digitizer.

FIG. 13 illustrates a method of accessing a non-terrestrial network.

FIG. 14 illustrates an example computer system comprising various hardware elements.

In the appended figures, similar components and/or features may have the same numerical reference label. Further, various components of the same type may be distinguished by following the reference label with a letter or by following the reference label with a dash followed by a second numerical reference label that distinguishes among the similar components and/or features. If only the first numerical reference label is used in the specification, the description is applicable to any one of the similar components and/or features having the same first numerical reference label, irrespective of the suffix.

### DETAILED DESCRIPTION OF THE INVENTION

Despite the widespread acceptance of Internet Protocol (IP) technology for communication and its various applications, including a shift to cloud and virtual platforms, the satellite industry has been slower in adopting this trend. This delay is attributed to the physical challenges posed by analog radio frequency (RF) technologies and the complexities associated with managing real-time data flow across IP networks. One challenge to achieving a fully enabled virtual ground station is how to reliably, confidently, and securely assure the conversion of RF waveforms into IP data without loss of quality. A second challenge is how to manage the distribution of this real-time data across IP networks and into cloud and virtual environments. These challenges are more than a simple digitization problem because hidden within each are several significant technical hurdles such as timing, network latency and jitter, error correction, among others.

Digital intermediate frequency (IF) technology expands the transmission of analog IF data onto IP-based networks. Digital IF offers the potential to introduce much-needed flexibility in ground station architectures. In some cases, through the use of IF digitizers and cloud processing resources, much of the conventional ground station architecture (typically consisting of an antenna, amplifiers, frequency converters, and a string of RF switches, modems, and other processing equipment) can be virtualized. The capability to digitize and transmit RF signals in real time, without data loss, effectively eliminates the constraints of distance and signal degradation associated with analog RF. Overcoming these limitations has been a significant challenge for operators aiming to optimize infrastructure investments and leverage the latest technologies, whether it involves transitioning ground systems to the cloud, centralizing (or decentralizing) operations, or mitigating service interruptions caused by atmospheric effects.

Digital IF allows antennas to be strategically positioned, taking into account factors such as cost, real estate availability, and signal reception optimization. The antenna placement can be decoupled from signal processing, enabling it to happen at any location and at any distance from the antenna. Consequently, the use of digital IF can systematically transport digitalized spectrum across an IP network and reconstruct it at the destination for processing by either digital or analog equipment. This process incurs minimal additional latency, preserves data integrity, and remains agnostic to the spectral content.

As network functions are virtualized and computing is proliferated at remote locations, the size, weight, power, and cost (SWaP-C) for enabling hardware becomes more and more constrained. These locations can be remote locations such as ships, planes, cars, and oil rigs, where satellite is the preferred access technology given its ubiquitous nature. A common way for edge compute nodes to gain access to networks is through add on cards like Wi-Fi or cellular add-on cards when they are located in terrestrial network service areas. These add-on cards can come in internal and external expansion options like M.2 or Peripheral Component Interconnect Express (PCIe). These standard form factors are low profile and have limited real estate, especially at the front panel of the board where connectors attach to interface with external antennas.

To further constrain the hardware real estate, radio modules with RF front ends have ports that may need to be isolated from one another on the front panel. In the case of an edge digitizer used to gain access to a satellite network, the digitizer converts L-band analog signals from a satellite antenna through its Tx and Rx ports. The Tx and Rx isolation may leave little room on expansion cards like M.2 and PCIe. As such, the option for having multiple input reference ports for pulse-per-second (PPS), 10 MHz, GPS, and IRIG signals becomes prohibitive. In some use cases, these timing and frequency references are important for supporting applications running on the compute infrastructure to ensure timing and frequency synchronization. Such use cases may include space to ground, space domain awareness, and satcom type use cases. Some applications utilize a PPS reference signal for sub-second reference timing resolutions and a 10 MHz reference signal for frequency locking.

Some embodiments of the present disclosure relate to a digitizer and methods for its operation for use at a ground station or a remote terminal of a satellite communication system. The digitizer can be deployed in an architecture that utilizes digital IF and network function virtualization (NFV). The digitizer may use a configurable logic device, such as a field-programmable gate array (FPGA), to generate digital IF packets containing digital IF waveforms of received analog signals. In the transmission path, the digitizer may convert digital IF packets containing digital IF waveforms into corresponding analog signals for transmission via an antenna. The configurable logic device may be configured by a configuration file that is produced by a management system.

In some embodiments, the digitizer may be a SWaP-C device that can be embedded into the hardware at the ground station or terminal. By using standard form factors like PCIe and standard data interfaces like the Digital Intermediate Frequency Interoperability (DIFI) standard, the digitizer can become agnostic, able to support an ecosystem of general-purpose compute nodes and antennas. Some embodiments may include an antenna and one or more compute nodes communicatively coupled to the digitizer. Such embodiments may be enabled by virtual network functions (VNFs) running on the compute nodes. For example, e.g. a virtual modem (e.g., implementing DVB-S2X, 5G, CDL, etc.) may enable a satellite communications edge terminal or a direct line of sight communications link (e.g. to an aircraft or unmanned aerial vehicle (UAV)), or a virtual spectrum analyzer may enable a space domain awareness (SDA) sensor, among other possibilities.

By digitizing the received signal and virtualizing the signal processing, the digitizer can be used to create a general-purpose terminal that can support one or more diverse functions at the same time and can be reconfigured to support completely new or complementary functions. Some example functions include satellite communications through a low Earth orbit (LEO) constellation, a medium Earth orbit (MEO) constellation, or a geostationary Earth orbit (GEO) constellation, an Earth observation or scientific satellite mission data download, a space domain awareness mission, or a telemetry, tracking, and command (TT&C) mission. The terminal compute infrastructure can be used to add backend functions like WiFi, 5G cellular, virtual routers, and firewalls for backend terrestrial communication. In some instances, the terminal can be separated from the signal processing by moving the signal processing off the terminal and onto a site-specific compute capability or cloud.

Some embodiments of the present disclosure relate to systems and methods for performing timing and frequency synchronization at a digitizer. Embodiments may utilize a single reference input (and accordingly a single reference port) for receiving a PPS signal (e.g., a 1 pulse-per-second (1 PPS) signal) for performing both system frequency lock (normally accomplished with a 10 MHz reference input) and sub-second timing. Embodiments may further utilize a high-precision digitally controlled temperature compensated crystal oscillator (DCTCXO) and a proportional-integral-derivative (PID) control loop to achieve high precision and low jitter/wander frequency control using the PPS timing reference signal.

Some embodiments of the present disclosure relate to techniques for accessing and communicating over a 5G or 6G non-terrestrial network. Such embodiments may entail virtualizing a 5G non-terrestrial network user equipment (UE) and running it on compute nodes, enabled by a digitizer that is agnostic to waveform, band, orbit, and network provider. This digitizer provides not only the digital IF generated from the analog coming from the terminal antenna but also Subscriber Identity Module (SIM) data from onboard SIMs and timing and location information from an onboard GNSS receiver. A universal edge digitizer can enable support for standard waveforms from 3rd Generation Partnership Project (3GPP) like 5G New Radio (NR) non-terrestrial network (NTN), 5G NB-IoT NTN, and also terrestrial 5G NR. Embodiments allow the combination of an edge digitizer with NTN enablement and compute nodes hosting a virtual UE.

Many benefits are achieved by way of the present disclosure. The single timing reference input enables a smaller form factor digitizer for standard expansion slots such as PCIe and non-standard expansion slots such as in antennas or embedded applications, while still being able to provide both timing and frequency synchronization needed to support a broad range of applications like TT&C, Earth observation, RF analysis, satcom, etc. As another example, while conventional terminals only process a particular portion of the RF spectrum, the described digitizer-equipped terminal can digitize a wide band of RF spectrum and can use VNFs to analysis the entire spectrum, not just the spectrum being processed for communications or other purposes, allowing the terminal to become aware of the wide band RF environment. Thus, a terminal can have intelligence and make decisions to adjust its operational environment (e.g. changing frequencies in the event of RF interference, changing networks or satellites in the event of a network or satellite problem, etc.). In some instances, a satcom model can also collect terminal, RF, and network data to enable artificial intelligence (AI)-based optimization of the network. Such benefits are unavailable with conventional terminal architectures using hardware-based modems with embedded digitizers.

In the following description, various examples will be described. For purposes of explanation, specific configurations and details are set forth in order to provide a thorough understanding of the examples. However, it will also be apparent to one skilled in the art that the example may be practiced without the specific details. Furthermore, well-known features may be omitted or simplified in order not to obscure the embodiments being described.

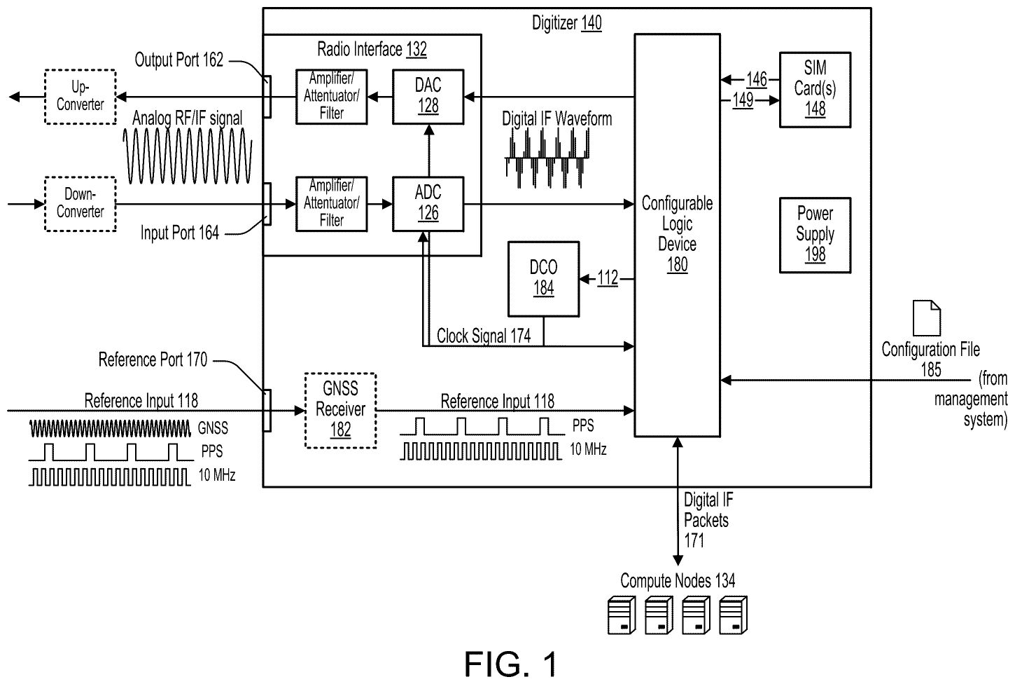

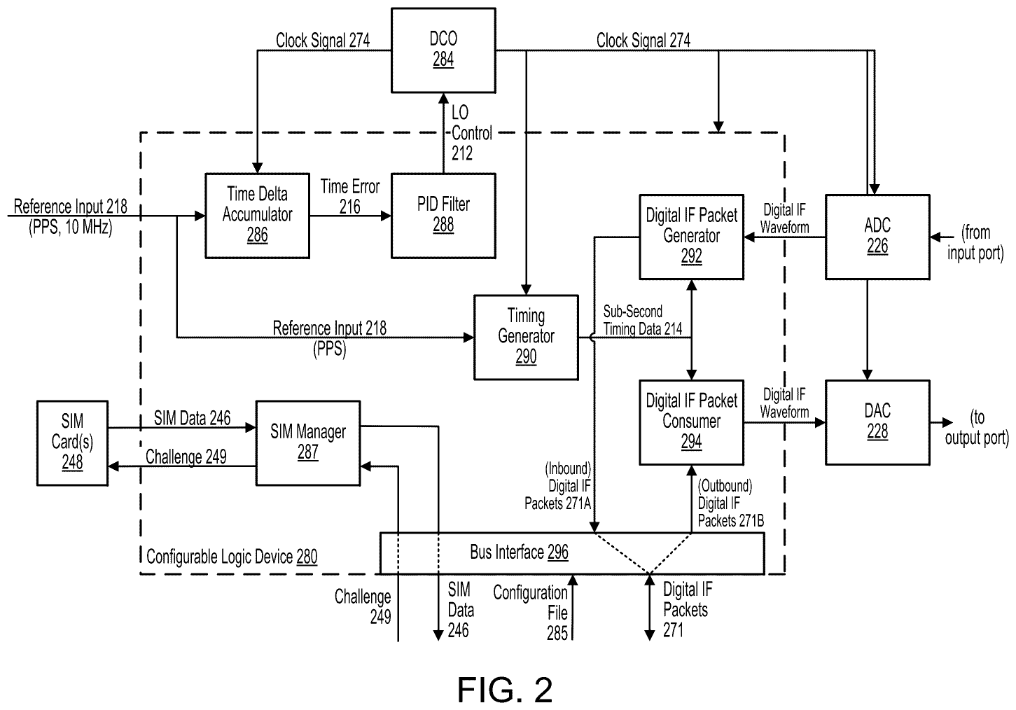

The figures herein follow a numbering convention in which the first digit or digits correspond to the figure number and the remaining digits identify an element or component in the figure. Similar elements or components between different figures may be identified by the use of similar digits. For example, 108 may reference element “08” in FIG. 1, and a similar element may be referenced as 208 in FIG. 2. As will be appreciated, elements shown in the various embodiments herein can be added, exchanged, and eliminated so as to provide a number of additional embodiments of the present disclosure. In addition, the proportion and the relative scale of the elements provided in the figures are intended to illustrate certain embodiments of the present disclosure and should not be taken in a limiting sense.

FIG. 1 illustrates an example architecture of a digitizer 140 deployed within a ground station or a remote terminal of a satellite communication system, in accordance with some embodiments of the present disclosure. At an input port 164 and an output port 162, digitizer 140 may be configured to respectively receive and send analog RF/IF signals within one or more bands of a number of possible frequency bands between 1-300 GHz including, for example, L Band (1-2 GHz), C-Band (4-8 GHz), X-Band (8-12 GHz), Ku-Band (12-18 GHz), Ka-Band (26.5-40 GHz), S-Band (2-4 GHz), and V-Band (40-75 GHz). In the reception path, an analog RF signal may optionally be down-converted (e.g., by a down-converter) into an analog IF signal that is received by a radio interface 132 of digitizer 140 via input port 164. In the transmission path, an analog IF signal that is outputted by radio interface 132 via output port 162 may optionally be up-converted (e.g., by an up-converter) into an analog RF signal that is sent to an antenna.

Radio interface 132 may include combinations of amplifiers, attenuators, and/or filters for respectively amplifying, attenuating, and/or filtering the analog RF/IF signal in the reception and transmission paths. In the reception path, radio interface 132 may include an analog-to-digital converter (ADC) 126 that samples the analog RF/IF signal at a sampling rate to produce a digital waveform at RF/IF frequencies (or “digital IF waveform”). The sampling rate of ADC 126 may be set to be at least twice the maximum frequency of the analog RF/IF signal to avoid aliasing. ADC 126 may sample the analog input at regular intervals, capturing the amplitude of the analog RF/IF signal at discrete points in time. The continuous amplitude values obtained during sampling may then be quantized into discrete digital values. This may involve mapping the analog RF/IF signal's amplitude to the nearest digital representation.

In the transmission path, radio interface 132 may include a digital-to-analog (DAC) 128 that receives a digital IF waveform, in the form of binary values (bits), and converts the digital IF waveform into a corresponding analog RF/IF signal. This may involve mapping each digital value to a specific voltage level. For example, in an 16-bit DAC, there are 2\hat{ }16 (65,536) possible digital values, each corresponding to a unique analog output level. The analog RF/IF signal that is outputted by DAC 128 may be fed through a combination of amplifiers, attenuators, and/or filters, outputted through output port 162, passed through an up-converter (e.g., to convert from IF to RF), and then sent to an antenna for wireless transmission within the satellite communication network.

Digitizer 140 may include a configurable logic device 180 that receives the digital IF waveform from ADC 126 in the reception path and sends the digital IF waveform to DAC 128 in the transmission path. Configurable logic device 180 may include digital circuits that can be programmed and reprogrammed in accordance with a configuration file 185 to perform specific tasks or functions. While configurable logic device 180 is generally described herein as being an FPGA, configurable logic device 180 may be any type of programmable logic device, such as a complex programmable logic device (CPLD), a programmable array logic (PAL), a generic array logic (GAL), a reconfigurable processor, a configurable application-specific integrated circuit (ASIC), a microcontroller with configurable logic, a field-programmable analog array, among other possibilities.

In some examples, configurable logic device 180 may include an array of configurable logic blocks (CLBs) that can be interconnected to implement custom digital circuits. Such CLBs may contain lookup tables (LUTs), flip-flops, multiplexers, and other digital circuit elements. Upon receiving configuration file 185 (from, e.g., a management system) at digitizer 140, the binary data contained in the configuration file 185 representing the configuration settings is loaded onto configurable logic device 180, causing the internal logic elements to be configured in accordance with the configuration settings.

Among other functions, configurable logic device 180 may be configured to generate digital IF packets 171 in accordance with the configuration settings based on the digital IF waveform that is received from ADC 126. For example, different streams of digital IF packets 171 may be generated to include all or portions (e.g., within a particular band of frequencies) of the digital IF waveform as indicated by the configuration settings. Each of digital IF packets 171 may include a digital IF waveform contained within the signal data payload of a signal data packet. Optionally, the signal data packet may be encapsulated within a UDP packet, which may be encapsulated within an IP packet, which may then be encapsulated within an Ethernet packet. Digital IF packets 171 may be sent/received between configurable logic device 180 and one or more compute nodes 134 via, for example, a PCIe bus.

In one example, the configuration settings of configuration file 185 may specify a first frequency band, a first time range (e.g., start and stop time stamps), and an identifier for a first VNF (e.g., a virtual receiver VNF performing demodulation). Upon configurable logic device 180 being configured with these configuration settings and upon configurable logic device 180 receiving a wide-band (e.g., 500 MHz) digital IF waveform from radio interface 132, configurable logic device 180 may be configured to generate digital IF packets 171 containing (within the signal data payload of the signal data packet) portions of the received digital IF waveform within the first frequency band and within the first time range. Such digital IF packets 171 may be constructed by configurable logic device 180 to include a destination address (following a standard formatting) such that digital IF packets 171 arrive at one of compute nodes 134 at which the first VNF is running.

Continuing with this example, the configuration settings of configuration file 185 may further specify a second frequency band (the same or different than the first frequency band), a second time range (the same or different than the first time range), and an identifier for a second VNF (e.g., a virtual spectrum analyzer enabling an SDA sensor). Upon configurable logic device 180 being configured with these configuration settings, configurable logic device 180 may be further configured to generate digital IF packets 171 containing (within the signal data payload of the signal data packet) portions of the received digital IF waveform within the second frequency band and within the second time range. Such digital IF packets 171 may be constructed by configurable logic device 180 to include a destination address (e.g., a destination MAC address) such that digital IF packets 171 arrive at one of compute nodes 134 at which the second VNF is running. In this manner, configuration file 185 may cause configurable logic device 180 to capture portions of the received digital IF waveform at different frequency ranges and different time segments, package those portions of the received digital IF waveform into digital IF packets 171, and route the packets to appropriate VNFs running on compute nodes 134.

On the transmission side, configurable logic device 180 may be configured to receive digital IF packets 171 from compute nodes 134 and extract all or portions (e.g., within a particular band of frequencies) of the digital IF waveform as indicated by the configuration settings. The extracted digital IF waveform may be sent by configurable logic device 180 to DAC 128 for conversion into an analog RF/IF signal for wireless transmission via an antenna. In some examples, upon receiving a digital IF packet, configurable logic device 180 may identify a particular VNF that sent the packet. For example, configurable logic device 180 may examine a packet header to identify the source address (e.g., a source MAC address) of the digital IF packet to determine the source VNF running on the compute node having the source address or, in some examples, the digital IF packet may directly include an identifier for the source VNF. In some examples, based on the source VNF, the configuration settings may indicate the manner in which the digital IF waveform contained within the digital IF packet is to be filtered, amplified, attenuated, delayed, or otherwise modified prior to sending the digital IF waveform to radio interface 132 for transmission.

In one example, the configuration settings of configuration file 185 may specify a first frequency band to be transmitted, a particular transmission time, and a first VNF (e.g., a first virtual transmitter VNF performing modulation) associated with the first frequency band and the particular transmission time. Upon configurable logic device 180 being configured with these configuration settings and upon configurable logic device 180 receiving a first digital IF packet, configurable logic device 180 may be configured to determine that the first digital IF packet was sent by the first VNF (e.g., by examining the source address), extract portions of the digital IF waveform contained within the signal data payload within the first frequency band, and send the portions of the digital IF waveform to radio interface 132 for wireless transmission at the particular transmission time.

Continuing with this example, the configuration settings of configuration file 185 may further specify a second frequency band to be transmitted (the same or different than the first frequency band), the particular transmission time, and a second VNF (e.g., a second virtual transmitter VNF performing modulation) associated with the second frequency band and the particular transmission time. Upon configurable logic device 180 being configured with these configuration settings and upon configurable logic device 180 receiving a second digital IF packet, configurable logic device 180 may be further configured to determine that the second digital IF packet was sent by the second VNF (e.g., by examining the source address), and extract portions of the digital IF waveform contained within the signal data payload within the second frequency band. Configurable logic device 180 may also combine the portions of the digital IF waveform in the first digital IF packet with the portions of the digital IF waveform in the second digital IF packet to create a composite digital IF waveform, which may be sent to radio interface 132 for wireless transmission at the particular transmission time.

Digitizer 140 may include a digitally controlled oscillator (DCO) 184 that generates a clock signal 174 (or local oscillator (LO) clock) that is used as the clock signal for ADC 126, DAC 128, and configurable logic device 180. Clock signal 174 may be an oscillating signal whose frequency can be digitally controlled or adjusted by configurable logic device 180 via a LO control 112 generated through a phase-locked loop implementing a PID controller. LO control 112 may have a digital value that causes the frequency of clock signal 174 to increase or decrease as LO control 112 is digitally tuned. Clock signal 174 may be used by each of DAC 128 and ADC 126 as a clock signal, setting the sampling rate for conversion between the analog and digital signals.

Digitizer 140 may include a reference port 170 in addition to input port 164 and output port 162, forming a three-port system. A reference input 118 received via reference port 170 may be used to handle timing within digitizer 140, both to generate clock signal 174 and to produce sub-second timing data used for timestamping digital IF packets 171. In the example of FIG. 1, reference input 118 received at reference port 170 may comprise a global navigation satellite system (GNSS) signal (e.g., a Global Positioning System (GPS) signal) received from one or more GNSS satellites, a PPS signal, or a 10 MHz signal (or other oscillating signal in the MHz range). For embodiments in which reference input 118 received at reference port 170 comprises a PPS signal or a 10 MHz signal, these signals may themselves have been derived from a GNSS signal received upstream from reference port 170.

For embodiments in which reference input 118 received at reference port 170 comprises a GNSS signal, digitizer 140 may include a GNSS receiver for extracting a PPS signal or a 10 MHz signal from the GNSS signal. In some examples, GNSS receiver 182 may generate a PPS signal through its internal clock synchronization mechanism. As the GNSS signals contain highly accurate timing information from the atomic clocks that are on board the satellites, GNSS receiver 182 can synchronize its clock to these signals and generate the PPS signal by dividing its clock frequency down to produce a pulse every second. This pulse indicates the start of each second with high accuracy, synchronized to the satellite time.

Digitizer 140 may include a power supply 198 that provides DC power to the components of digitizer 140 to maintain proper performance. For example, power supply 198 may provide the required voltage and current to each of DAC 128, ADC 126, DCO 184, configurable logic device 180, GNSS receiver 182, as well as any amplifiers, attenuators, and filters included in radio interface 132. Power supply 198 may include one or more batteries (for portable or remote terminals) or, in some examples, power supply 198 may accept external power from an AC or DC external source. Power supply 198 may include a power management unit (PMU) that optimizes power distribution to different components of digitizer 140. This can include dynamic adjustment of power delivery based on the operating state (e.g., active, idle, or standby).

In some embodiments, digitizer 140 may include one or more SIM cards 148 to enable communication within one or more terrestrial networks (e.g., a cellular network or mobile network) or non-terrestrial networks. In some examples, SIM card 148 may include a microprocessor that uses data stored therein to produce SIM data 146 that allows the ground station or the remote terminal to access a terrestrial or non-terrestrial network or, in some examples, a 5G non-terrestrial network. SIM data 146 may include a user identifier that identifies the communication unit (ground station or remote terminal) or the user operating the communication unit. The identifier may be the user's International Mobile Subscriber Identity (IMSI), Subscription Permanent Identifier (SUPI), or Subscription Concealed Identifier (SUCI), which is a temporary, encrypted version of the user's IMSI or SUPI. SIM data 146 may be encrypted to ensure privacy and security.

In some examples, SIM data 146 may include an authentication response for secure network access. The authentication response included in SIM data 146 may include an authentication key or may include data generated based on the authentication key using cryptographic algorithms. In some examples, SIM data 146 may include device capability information, such as supported frequency bands or supported security features. The device capability information may indicate both supported transmit frequency bands and supported receive frequency bands. In some examples, the device capability information indicates which 5G frequency bands are supported, such as Frequency Range 1 (FR1), Frequency Range 2 (FR2), or Frequency Range 3 (FR3) and sub-bands therein (e.g., n1 band, n2 band, n3 band, etc.).

SIM card 148 may be implemented as a physical, removable SIM card or as an embedded SIM (eSIM) that is embedded directly into digitizer 140. An eSIM may be remotely provisioned to store certain data by a network operator, allowing the user to switch between networks or update profiles without physically changing the SIM card. In various examples, SIM card 148 may be implemented as one of various physical SIMs (such as full-size SIM, mini SIM, micro SIM, or nano SIM), specialized SIMs (such as M2M SIM, or Multi-IMSI SIM), or even emerging technologies such as iSIM or programmable SIMs. In some examples, SIM card 148 may implement a universal SIM (USIM), which is an advanced type of SIM card specifically designed for use in 3G, 4G, and 5G networks.

FIG. 2 illustrates an example architecture of a configurable logic device 280 of a digitizer, in accordance with some embodiments of the present disclosure. Configurable logic device 280 may include a time delta accumulator 286 and a PID filter 288, together with a DCO 284 (which may be a high-precision DCTCXO) form a phase-locked loop that generates a clock signal 274 and achieves precise frequency and phase control. The output of the phase-locked loop is clock signal 274, which is generated by DCO 284 to have a frequency that is proportional to a LO control 212, a signal generated by PID filter 288. Time delta accumulator 286 may receive a reference input 218 (comprising a PPS signal or a 10 MHz signal) and clock signal 274 and compute the time difference (or time delta) between a single oscillation of reference input 218 and a particular number of oscillations of clock signal 274. The time deltas are accumulated over time to compute a time error 216 that is sent to PID filter 288. The particular number of oscillations of clock signal 274 that is tracked by time delta accumulator 286 for computing each time delta may be the target frequency of clock signal 274, e.g., 3×10⁷ oscillations for 30 MHz, 4×10⁷ oscillations for 40 MHz, 5×10⁷ oscillations for 50 MHz, among other possibilities.

PID filter 288 may process time error 216 generated by time delta accumulator. PID filter 288 performs a combination of three different control actions, including a proportional control (e.g., responding to the current value of time error 216), integral control (responding to the accumulated value of time error 216 over time), and derivative control (responding to the rate of change of time error 216). PID filter 288 outputs LO control 212 to adjust the digital control word of DCO 284, completing a feedback loop. Functionally, PID filter 288 helps to stabilize the phase-locked loop, ensuring fast acquisition and low jitter. PID filter 288 can be tuned to optimize the phase-locked loop's stability, transient response, and noise rejection. In this manner, the DCO is controlled to lock a frequency of clock signal 274 to a multiple of a frequency of the PPS signal.

Configurable logic device 280 may include a timing generator 290 that receives the PPS signal of reference input 218 and clock signal 274 and generates sub-second timing data 214. Using an initial time reference, timing generator 290 may count seconds using the PPS signal, thereby effectively measuring seconds from a known start point. The initial time reference may be derived from information from the GNSS signal, manually set, or obtained via synchronization with an internet time server using protocols like NTP or PTP. This allows timing generator 290 to know the absolute time associated with a specific PPS pulse. Since each rising edge of the PPS signal represents the start of a new second, counting these pulses can incrementally update the time from the initially set reference. The system clock is updated with each pulse, accounting for seconds, minutes, hours, day changes, and leap seconds as necessary.

To achieve sub-second accuracy for the system clock, timing generator 290 uses clock signal 274 and the target frequency used by the phase-locked loop to perform the frequency lock. Timing generator 290 may count the number of oscillations of clock signal 274 since the last rising edge of the PPS signal and multiply by the inverse of the target frequency. For example, for a target frequency of 40 MHz each oscillation corresponds to 25 ns, which may be multiplied by the number of oscillations to obtain the sub-second component of the system time. The seconds component (computed using the PPS signal) and the sub-second component (computed using the PPS signal and clock signal 274) of the system time are added and sent as sub-second timing data 214 to a digital IF packet generator 292 and a digital IF packet consumer 294 of configurable logic device 280.

ADC 226 uses clock signal 274 to sample and convert an analog IF/RF signal into a digital IF waveform, which is sent to digital IF packet generator 292. In accordance with the configuration settings of a configuration file 285, digital IF packet generator 292 may be configured to generate inbound digital IF packets 271A based on the digital IF waveform that is received from ADC 226. For example, different streams of digital IF packets 271A may be generated to include all or portions (e.g., within a particular band of frequencies) of the digital IF waveform as indicated by the configuration settings. Digital IF packet generator 292 may insert the system time from sub-second timing data 214 as timestamps into the signal packet headers of digital IF packets 271A. Generated inbound digital IF packets are then sent via a bus interface 296 (e.g., a PCIe bus) to a compute infrastructure including one or more compute nodes. Inbound digital IF packets 271B having timestamps with sub-second precision are important in certain applications, such as time division multiple access (TDMA) satellite communications, TT&C, and space-to-ground (S2G) communication.

Outbound digital IF packets 271B are received by digital IF packet consumer 294 from the compute nodes via bus interface 296. In accordance with the configuration settings of configuration file 285, digital IF packet consumer 294 may extract all or portions (e.g., within a particular band of frequencies) of the digital IF waveform contained in outbound digital IF packets 271B. In some examples, digital IF packet consumer 294 may use the system time from sub-second timing data 214 to convert outbound digital IF packets 271B into the digital IF waveform. DAC 228 uses clock signal 274 to convert the digital IF waveform into an analog IF/RF signal by controlling the sampling and conversion process in the DAC, which may be implemented using delta-sigma (oversampling) conversion or ladder DAC conversion. For delta-sigma conversion, DAC 228 converts the digital IF waveform into a high-frequency bitstream, which is then filtered through a low-pass filter to produce the final analog output signal. Clock signal 274 is used to synchronize the input data sampling and the filtering process to ensure that the correct data samples are used for each conversion cycle. In a ladder DAC, clock signal 274 is used to control the switching of the resistor network and the sampling of the digital IF waveform, which are then used to determine the analog output voltage through a series of voltage comparisons.

In some examples, configurable logic device 280 may include a SIM manager 287 that may write or read data to/from one or more SIM cards 248. In some examples, a network access challenge 249 is received at SIM manager 287 and/or SIM card 248 from one or more VNFs running on the compute nodes. In response, SIM manager 287 and/or SIM card 248 may generate SIM data 246, which may include one or more of (1) a user/device identifier, such as an IMSI, a SUPI, or a SUCI, (2) an authentication response to network access challenge 249 (e.g., a cryptographic response to a RAND), or (3) device capability information. In some examples, SIM card 248 or SIM manager 287 may generate the authentication response or they may send data to the compute nodes where the authentication response may be generated. SIM data 246 may be sent by SIM manager 287 and/or SIM card 248 to the VNFs running on the compute nodes. In some examples, such as for eSIMs or programmable SIMs, SIM manager 287 may receive updated data from the compute nodes that is to be stored on SIM card 248. Upon receiving the updated data, SIM manager 287 may overwrite or replace the data stored on one or more of SIM cards 248 with the updated data.

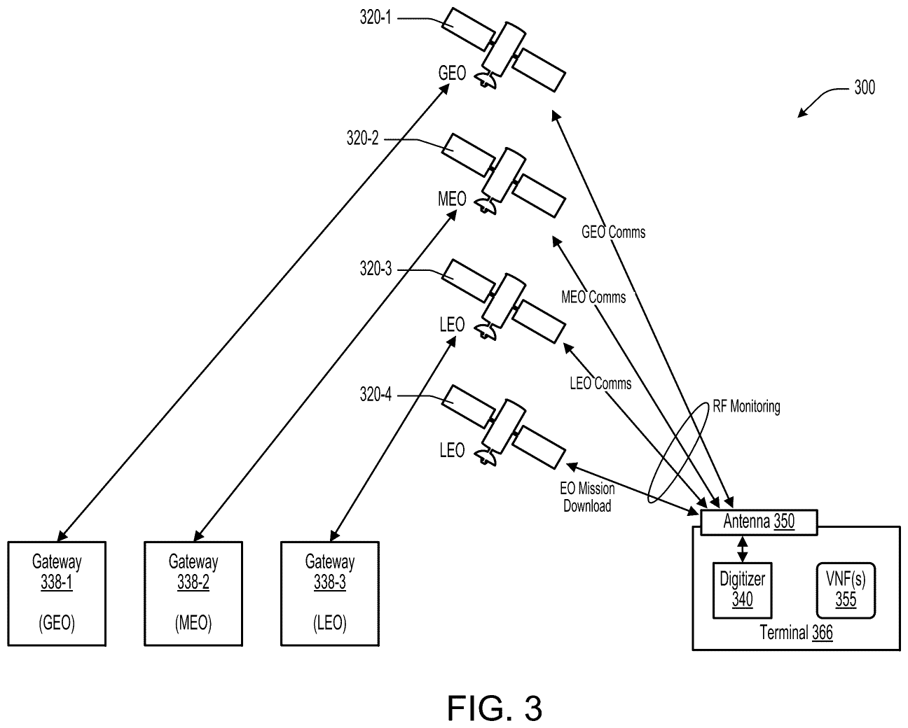

FIG. 3 illustrates an example satellite communication system 300 including a set of gateways 338 and a terminal 366 (or “remote terminal”), in accordance with some embodiments of the present disclosure. Each of gateways 338 are in communication with terminal 366 via one of a set of satellite 320 operating in different types of orbit. In the illustrated example, gateway 338-1 communicates with terminal 366 via satellite 320-1 operating in GEO, gateway 338-2 communicates with terminal 366 via satellite 320-2 operating in MEO, and gateway 338-3 communicates with terminal 366 via satellite 320-3 operating in LEO. An additional LEO satellite, satellite 320-4, can be used to perform an Earth observation (EO) mission download to transfer the collected data from satellite 320-4 to terminal 366.

The multi-mission capabilities of terminal 366 may be enabled by a digitizer 340, which may have the structure and capabilities of digitizer 140 described in reference to FIG. 1. For example, by configuring digitizer 340 in various ways, terminal 366 can perform multi-missions, switching between them and, in some examples, depending on the capability of antenna 350, terminal 366 may perform many of such missions or functions at the same time. Many functions may be supported by VNFs 355 running on the compute infrastructure of terminal 366. In some examples, VNFs 355 may include one or more modulators, demodulators, traffic adapters, and/or various VNFs supporting GEO communications, MEO communications, LEO communications, EO mission download, RF monitoring, among other possibilities.

In some examples, antenna 350 may be an electronically steerable antenna configured to simultaneously form four separate beams, each directed to one of satellites 320, enabling sending/receiving wireless signals to/from satellites 320 over a wide or narrow frequency spectrum (e.g., 1-4 GHz, 900-910 MHz, 1.5-2.5 GHz, 14.0-14.5 GHz). In some examples, antenna 350 may be a parabolic antenna with a single beam that changes between sending/receiving wireless signals to/from satellites 320 as the four different functions require.

In one particular example, terminal 366 is configured to concurrently receive wireless signals from the four satellites. For example, terminal 366 may be configured to receive first wireless signals from gateway 338-1 via satellite 320-1 at a first frequency band (e.g., 14.100-14.105 GHz), second wireless signals from gateway 338-2 via satellite 320-2 at a second frequency band (e.g., 14.200-14.205 GHz), third wireless signals from gateway 338-3 via satellite 320-3 at a third frequency band (e.g., 14.300-14.305 GHz), and fourth wireless signals from satellite 320-4 at a fourth frequency band (e.g., 14.400-14.405 GHz). Since antenna 350 may be steerable so to form separate beams pointing in different directions, in some examples the first, second, third, and fourth frequency bands may completely or partially overlap.

Digitizer 340 may receive a composite analog signal that includes the first, second, third, and fourth wireless signals. Digitizer 340 may then digitize the entire spectrum (e.g., between 14.0-14.5 GHz) and then the digital IF signals may be channelized on the downlink stream into four individual signals of interest and an additional signal for RF monitoring. For example, digitizer 340 may generate a first stream of digital IF packets containing digitized first wireless signals (within the first frequency band), a second stream of digital IF packets containing digitized second wireless signals (within the second frequency band), a third stream of digital IF packets containing digitized third wireless signals (within the third frequency band), a fourth stream of digital IF packets containing digitized fourth wireless signals (within the fourth frequency band), and a fifth stream of digital IF packets containing digitized wireless signals across at least the first, second, third, and fourth frequency bands (e.g., between 14.0-14.5 GHz), which may be referred to as a fifth frequency band.

Upon digitizing the received composite analog signal, digitizer 340 may send the five generated streams of digital IF packets to different ones of VNFs 355 based on the particular application. For example, the first, second, and third streams may be respectively sent to first, second, and third VNFs (or first, second, and third sets of VNFs) supporting satellite communications applications, the fourth stream may be sent to a fourth VNF (or a set of VNFs) supporting the mission download application, and the fifth stream may be sent to a fifth VNF (or a set of VNFs) supporting the RF monitoring application. The RF monitoring application may monitor the health and performance of the first, second, third, and fourth wireless signals or, in some examples, the RF monitoring application may monitor the entire spectrum (e.g., the fifth frequency band).

During operation, the RF monitoring application may determine that the first frequency band has excessive RF interference, but that the second and third frequency bands have low RF interference. In response, the RF monitoring application may generate a command to move the first frequency band to be near (or aligned with) the second frequency band. For example, the RF monitoring application may generate a command to move the first frequency band from 14.100-14.105 GHz to 14.205-14.210 GHz. The command may be received by the management system, which may then reconfigure digitizer 340 (e.g., by generating a configuration file having new configuration settings) to begin generating the first stream of digital IF packets to contain (within the signal data payload of the signal data packet) portions of the digital IF waveform within the moved first frequency band (e.g., 14.205-14.210 GHz).

The RF monitoring application and other spectral awareness applications can provide important information to allow terminal 366 to intelligently restore full network performance. In some instances, such applications may detect various issues with a frequency band (e.g., the first frequency band) that include (1) RF interference, (2) an overdriven amplifier, (3) a problem on a specific satellite transponder or component that impacts only part of the available frequency band, (4) failure of a particular satellite, among other possibilities. In response to detecting any of the above issues, a spectral awareness application (such as the above-described RF monitoring application) can notify the management system of the particular issue(s), perform corrective measures if available (such as finding another compatible network on a different satellite if the issue is satellite specific), and/or generate commands to move the frequency band being used to a new set of frequencies.

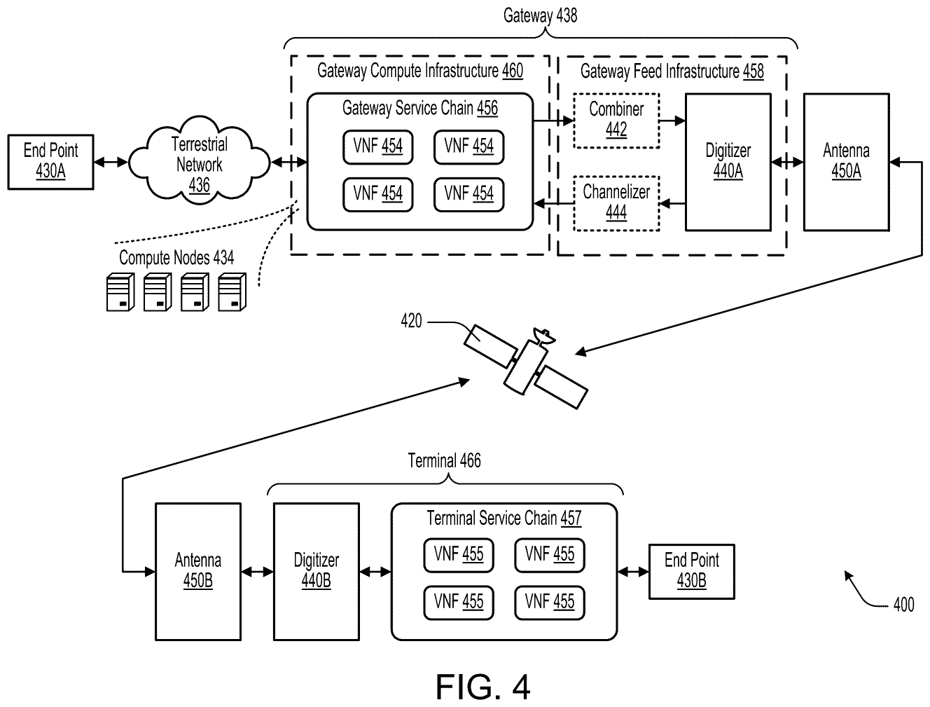

FIG. 4 illustrates an example communication path between an end point 430A and an end point 430B enabled by a satellite communication system 400, in accordance with some embodiments of the present disclosure. In the illustrated example, satellite communication system 400 includes a gateway 438 in communication with a terminal 466 via a satellite 420. In various examples, satellite 420 may send and receive wireless signals within one or more bands of a number of possible frequency bands between approximately 0.9-300 GHz including, for example, L Band (1-2 GHz), S-Band (2-4 GHz), C-Band (4-8 GHz), X-Band (8-12 GHz), Ku-Band (12-18 GHz), Ka-Band (26.5-40 GHz), and V-Band (40-75 GHz).

In various examples, end points 430 may correspond to portable mobile devices, internet of things (IoT) devices, desktop computers, user terminals, or any of a number of devices with communication capabilities. Alternatively, end points 430 may correspond to networks such as mobile towers, mining sites, ships, planes, or the like. In one example, end point 430A may correspond to a service and end point 430B may correspond to a consumer. It should be understood that the satellite communication environment may comprise other end points 430 and/or other arrangements of components than those illustrated. Furthermore, multiple communication paths may be constructed and operated in parallel, and separate communication paths may have different arrangements from each other.

End point 430A may be communicatively connected via a terrestrial network 436 (e.g., comprising the Internet, a private telecom backbone, or a cloud compute center) to a gateway 438. Gateway 438 may include one or more switches (not shown) to facilitate communication between the various components, such as a first switch at the boundary between terrestrial network 436 and a gateway compute infrastructure 460, and a second switch at the boundary between gateway compute infrastructure 460 and a gateway feed infrastructure 458. Such switches may be physical or virtual Gigabit Ethernet (GigE) switches. However, it should be understood that the above-described first and second switches could be implemented in the same switch. In some examples, the first switch may implement transport from terrestrial network 436 to a VNF 454 within a gateway service chain 456. In such a case, VNF 454 may act as a User Network Interface (UNI) or an External Network-Network Interface (ENNI) as defined by the applicable MEF Ethernet services and MEF operator services standards. Alternatively, the first switch may itself represent the UNI as defined by the applicable MEF standards.

Gateway compute infrastructure 460 may include a set of compute nodes 434 situated onsite (at a same physical location) or offsite (at a different physical location) relative to antenna 450. In some examples, compute nodes 434 may comprise general-purpose computers or servers capable of running VNFs 454 (e.g., as workloads) and other virtualization software such as hypervisors to support gateway service chain 456. In some examples, compute nodes 434 may employ x86 architectures, ARM architectures, RISC-V architectures, among other possibilities. Compute nodes 434 may be configured as clusters, data centers, warehouse-scale computers, among other possibilities. Gateway compute infrastructure 460 may further include suitable storage systems that provide persistent and reliable storage in support of VNFs 454.

In some examples, gateway compute infrastructure 460 may include a managing system that instantiates and configures one or more VNFs 454 to form gateway service chain 456. Two sets of one or more VNFs 454 may provide two-way communication, including a transmission path and a reception path, between terrestrial network 436 and a gateway feed infrastructure 458 of gateway 456. It should be understood that in an example in which gateway service chain 456 provides only one-way communication, VNFs 454 may provide only a transmission path without providing a reception path. The set of VNFs 454 (e.g., implementing a gateway) on the forward path towards the link to satellite 420, may comprise or constitute a traffic handler, an encapsulator (e.g., implementing generic stream encapsulation (GSE)), a modulator (e.g., the OpenSpace™ Wideband Software modulator, offered by Kratos Defense & Security Solutions, Inc. of San Diego, California), a combiner, an encryption/decryption VNF, a time division multiple access (TDMA) resource allocator, an antenna controller, among other possibilities.

This set of VNFs 454 on the transmission path may convert protocol data units (PDUs) into a digital signal (such as a digital intermediate frequency (IF) waveform or a composite digital IF waveform). For example, the traffic handler may process data link layer (e.g., Layer 2 or L2 in the Open Systems Interconnection (OSI) model) and/or network layer (e.g., Layer 3 or L3 in the OSI model) traffic, and provide the processed Ethernet frames or IP packets to the encapsulator. The encapsulator may convert the PDUs into baseband frames, and provide the baseband frames to the modulator. A baseband frame may be the basic unit of transmission in satellite communication system 400. The encapsulator may form baseband frames in accordance with the 5G standard, the DVB-S2X standard, described in European Telecommunications Standards Institute (ETSI) European Standard (EN) 302 307-1 v1.4.1 (2014-11), among other possible standards. The encapsulator may comprise one or more VNFs 454 (or software subprocesses) that perform one or more of the following functions: frame chopping, forward modulation selection (e.g., with Adaptive Coding and Modulation (ACM)), Ethernet bridge (e.g., Media Access Control (MAC) table, smart bridging/learning/relay, etc.), Address Resolution Protocol (ARP) (e.g., Ethernet MAC discovery), VLAN manipulation (e.g., to rewrite Ethernet frames on ingress/egress based on the MEF service definition), header compression (e.g., Robust Header Compression (ROHC)); and/or OTA optimization (e.g., Space Communications Protocol Specifications (SCPS)/TCP-Acceleration). The modulator may convert the baseband frames into signal data packets in accordance with a particular standard, including the standards of the Digital Intermediate Frequency Interoperability (DIFI) Consortium in the DIFI/Institute of Electrical and Electronics Engineers (IEEE) 1.0 specification, the VMEbus International Trade Association (VITA) standard, the enhanced Common Public Radio Interface (eCPRI) standard, among other possibilities. In an embodiment, the encapsulator and the traffic handler may be implemented as a single VNF 454, referred to as a virtualized traffic adaptor (vModem). The VNF-implemented combiner or a combiner 442 (implemented in hardware) may combine the signal data packets into a digital signal and provide the digital signal to a digitizer 440A, which may convert the digital signal into an analog signal.

The set of VNFs 454 on the return path may comprise or constitute, in order, a digital channelizer (e.g., the OpenSpace™ Wideband Channelizer, offered by Kratos Defense & Security Solutions, Inc. of San Diego, California), a demodulator (e.g., the OpenSpace™ Wideband Software Receiver, offered by Kratos Defense & Security Solutions, Inc. of San Diego, California), and a decapsulator. This set of VNFs 454 on the reception path may convert a digital signal (such as a digital IF waveform or a composite digital IF waveform) to PDUs, which may be Ethernet frames or IP packets, among other possibilities. For example, the VNF-implemented channelizer or a channelizer 444 (implemented in hardware) may receive a digital signal from digitizer 440A, which has converted an analog signal into the digital signal, and divide the digital signal into signal data packets. The demodulator may convert the signal data packets to baseband frames, and provide the baseband frames to the decapsulator. The decapsulator may convert the baseband frames into PDUs, which may be transmitted, via terrestrial network 436, to end point 430A. It should be understood that the demodulator performs the reverse function(s) of the modulator, and the decapsulator performs the reverse function(s) of the encapsulator. In an embodiment, the decapsulator and demodulator may be implemented as a single VNF 454, for example, together with the traffic handler, encapsulator, and modulator, in a vModem. In other words, a vModem may consist of a single VNF 454 that implements all of the functions of the traffic handler, encapsulator/decapsulator, and modulator/demodulator.

In some embodiments, in which gateway service chain 456 implements a vModem, the vModem may comprise one or more modulators that are configured to modulate waveforms according to a digital satellite broadcast standard and/or one or more demodulators that are configured to demodulate waveforms according to a digital satellite broadcast standard. Such a vModem may provide carrier ethernet (CE) services, in which case the vModem may comprise one or more encapsulators that convert Ethernet frames into baseband frames that are modulated into waveforms by the modulator(s), and one or more decapsulators that convert baseband frames, which have been demodulated from waveforms by the demodulator(s), into Ethernet frames. The digital satellite broadcast standard may be a digital satellite television broadcast standard, such as the DVB-S2X standard managed by the Digital Video Broadcasting (DVB) Project. While a digital satellite broadcast standard, such as a DVB standard, is used as an example, the vModem may be configured to modulate and demodulate waveforms according to other standards for wideband digital communication, such as orthogonal frequency-division multiplexing (OFDM), or the like.

The digital signal from combiner 442 is transmitted to digitizer 440A, which converts the digital signal output by combiner 442 into an analog transmission signal for communication to satellite 420. Digitizer 440A further digitizes analog reception signals from satellite 420 into digital signals for use by channelizer 444. In some examples, digitizer 440A may be software-defined. As one example, digitizer 440A may be a SpectralNet™, which is a carrier-grade RF digitizer, offered by Kratos Defense & Security Solutions, Inc. of San Diego, California. Digitizer 440A communicates with antenna 450A. In particular, digitizer 440A provides the transmission signal to antenna 450A, which transmits the transmission signal to satellite 420. In addition, in two-way communications, antenna 450A receives a reception signal from satellite 420, and provides the reception signal to digitizer 440A.

In various examples, antenna 450A may be a parabolic reflector antenna, a flat panel antenna, a phased array antenna, a helical antenna, a patch antenna, a horn antenna, among other possibilities. In some examples, antenna 450A may be an electronically steered antenna that can use electronic means to control the direction and shape of its radiation pattern. Such an antenna can generate multiple beams simultaneously, allowing it to transmit or receive signals in multiple directions at the same time. Antenna 450A may include both the physical antenna as well as the corresponding radio frequency (RF) subsystem, which may include a combination of diplexers, amplifiers (e.g., low noise amplifiers (LNAs)), upconverters, and downconverters (e.g., low-noise block downconverters (LNBs) depending on the specific frequency band and application.

Satellite 420 relays wireless signals from antenna 450A to antenna 450B. In two-way communications, satellite 420 also relays wireless signals from antenna 450B to antenna 450A. Antenna 450B may be functionally similar or identical to antenna 450A, and therefore, any description of antenna 450A applies equally to antenna 450B, which may not be redundantly described herein. Similarly, digitizer 440B may be functionally similar or identical to digitizer 440A, and therefore, any description of digitizer 440A applies equally to digitizer 440B, which may not be redundantly described herein.

Digitizer 440B may communicate directly with a terminal service chain 457 of a terminal compute infrastructure. Terminal service chain 457 may comprise a set of VNF(s) 455 forming a reception path from digitizer 440B to end point 430B. In two-way communications, terminal service chain 457 may also comprise a set of VNFs 455 forming a transmission path from end point 430B to digitizer 440B. The reception and transmission paths may be identical or similar to the reception and transmission paths described with respect to gateway service chain 456. For example, the reception path may comprise a demodulator followed by a decapsulator to convert signal frames into PDUs, and the transmission path may comprise an encapsulator followed by a modulator to convert PDUs into signal frames. The traffic handler, encapsulator, decapsulator, modulator, and demodulator may all be similar or identical to those described with respect to gateway service chain 456, and therefore, the descriptions of those components with respect to gateway service chain 456 apply equally to those components in terminal service chain 457.

Terminal service chain 457 may communicate with end point 430B. For example, the traffic handler of terminal service chain 457 may transmit Ethernet frames to end point 430B. In addition, in two-way communications, the encapsulator of terminal service chain 457 may receive PDUs from end point 430B. Thus, the combination of gateway service chain 456 and terminal service chain 457 enable one-way or two-way communications between end points 430A and 430B over a satellite link.

Gateway service chain 456 and terminal service chain 457 may comprise one or more of the software-defined components (e.g., VNFs and/or digitizers) described in International Patent App. Nos. PCT/US2021/033867, filed on May 24, 2021, PCT/US2021/033875, filed on May 24, 2021, PCT/US2021/033905, filed on May 24, 2021, and PCT/US2021/062689, filed on Dec. 9, 2021, which are all hereby incorporated herein by reference as if set forth in full.

Advantageously, the utilization of VNFs and software-defined components (e.g., digitizers 440A and 440B) to perform various functions, aid in automation and scalability. Embodiments may minimize the presence of physical hardware components, such that satellite communication system 400 can be dynamically reconfigured (e.g., added, updated, destroyed, increased or decreased in dimension, etc.) in real time, primarily using in-band network communications, to adapt to the unique multivariate satcom environment (e.g., changing traffic patterns, RF interference, atmospheric characteristics, antenna conditions, path length, etc.).

Notably, dynamic reconfiguration of VNFs in a cloud computing environment can be used, not only to increase the dimensions of the computing resources (e.g., number of vCPUs, amount of memory and/or disk storage, network throughput, etc.) used for satellite communication system 400 on demand to ensure the sufficiency of the satellite communication system, but also to decrease the dimensions of the computing resources on demand to optimize the utilization of the hardware. For example, favorable changes in the satcom environment may improve performance of satellite communication system 400, such that satellite communication system 400 is providing significantly better performance than is required by the service level agreement. In this case, the management system may determine that gateway service chain 456 and terminal service chain 457 are insufficient, and update the service chains to reduce the resources used in the service chains (e.g., by reducing RF bandwidth usage, resizing one or more VNFs, swapping to a service chain with reduced dimensions, etc.). This is in contrast to conventional hardware-based service chains in which unused resources would simply be idled or otherwise ignored, representing a sunk cost that cannot be recouped.

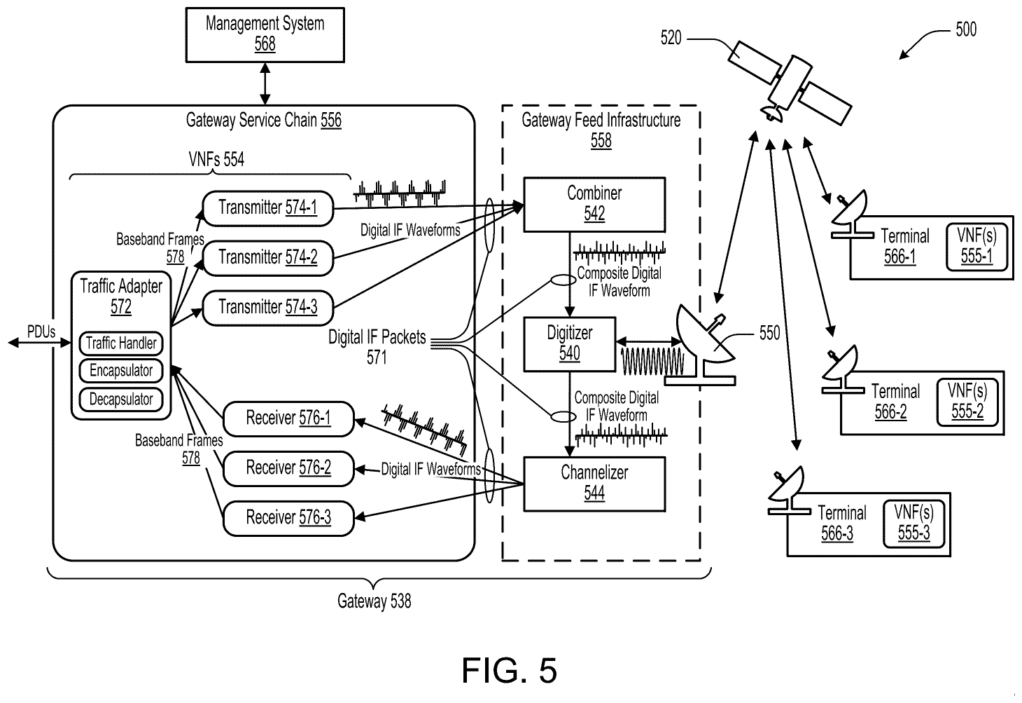

FIG. 5 illustrates an example satellite communication system 500 including a gateway 538 and a set of terminals 566 (or “remote terminals”), in accordance with some embodiments of the present disclosure. In the illustrated example, satellite communication system 500 includes a gateway 538 (or “hub”) in communication with each of terminals 566 via a satellite 520. Gateway 538 may include a gateway feed infrastructure 558 that serves as an onsite infrastructure (close to antenna 550, e.g., at a same physical location) that may perform primarily signal digitization and signal routing-related tasks and a gateway compute infrastructure that can be onsite or offsite infrastructure (far from antenna 550, e.g., at a different physical location) that supports a gateway service chain 556 that performs primarily signal processing and packet processing-related tasks. The gateway compute infrastructure may include one or more computers, clusters, a data center, or a warehouse-scale computer. The compute nodes comprising the gateway compute infrastructure and/or gateway feed infrastructure 558 may include general-purpose computers or servers employing x86 architectures, ARM architectures, RISC-V architectures, among other possibilities.

Gateway 538 may include a gateway service chain 556 comprising a set of VNFs 554 running on the gateway compute infrastructure. Examples of VNFs 554 include one or more traffic adapters 572, one or more virtual transmitters 574, one or more virtual receivers 576, among other possibilities. Each of VNFs 554 may be instantiated and configured by a management system 568 that scales up or down the number of active VNFs based on the number of active terminals 566. Management system 568 may further configure VNFs 554 such that satellite communication system 500 implements any one of a number of network topologies, including a single channel per carrier (SCPC) network, a TDMA network, a frequency division multiple access (FDMA) network, a mesh network, among other possibilities.

Traffic adapter 572 acts as the bridge between the terrestrial network and the satellite network. In some examples, traffic adapter 572 may include a traffic handler that processes data link layer (e.g., Layer 2 in the OSI model) and/or network layer (e.g., Layer 3 in the OSI model) traffic and provides the processed PDUs to the encapsulator, which convert the PDUs into baseband frames 578 and provides baseband frames 578 to one of virtual transmitters 574. On the reception path, baseband frames 578 produced by virtual receivers 576 are received by the decapsulator of traffic adapter 572. The decapsulator may convert baseband frames 578 into Ethernet frames and pass the Ethernet frames to the traffic handler, which processes and provides the Ethernet frames to a terrestrial network.

Virtual transmitters 574 provide transmission paths between a terrestrial network and a gateway feed infrastructure 558 of gateway 538. Each of virtual transmitters 574 on a transmission path may comprise or constitute a forward error correction (FEC) encoder that adds redundant bits according to a particular error-correcting code and a modulator (e.g., the OpenSpace™ Wideband Software modulator) that converts incoming baseband frames 578 into digital IF packets 571 containing digital waveforms at IF or RF frequencies (or “digital IF waveforms”). Each of virtual transmitters 574 may implement a modulator that converts baseband frames 578 into digital IF packets 571 (e.g., according to the standards of the DIFI Consortium in the DIFI/IEEE 1.2 specification) to create the digital IF waveforms.

Digital IF packets 571 generated by virtual transmitters 574 may be fed into a combiner 542 that combines the multiple digital IF waveforms into a single composite signal (or “composite digital IF waveform”). Digital IF packets 571 containing the composite digital IF waveform is fed into a digitizer 540 that converts the digital signal into an analog signal in preparation for wireless transmission via an antenna 550. While combiner 542 is illustrated in FIG. 5 as being an element of gateway feed infrastructure 558, it is to be understood that a combiner VNF (or multiple combiner VNFs) may be instantiated by management system 568 to perform similar functionality.

On the reception path, digitizer 540 digitizes analog signals received from satellite 520 to generate digital IF packets 571 containing digital IF waveforms (e.g., a composite digital IF waveform) of the received analog signals for use by a channelizer 544. The composite digital IF waveform received by channelizer 544 may be a wide-band spectrum (e.g., 100 MHz, 500 MHz, 3 GHz, etc.) that may contain several signals within that segment of the frequency band. In some instances, channelizer 544 divides the composite digital IF waveform into separate digital IF waveforms and sends the waveforms (in the form of digital IF packets 571) to appropriate virtual receivers 576. While channelizer 544 is illustrated in FIG. 5 as being an element of gateway feed infrastructure 558, it is to be understood that a channelizer VNF (or multiple channelizer VNFs) may be instantiated by management system 568 to perform similar functionality.

Virtual receivers 576 provide reception paths between gateway feed infrastructure 558 and a terrestrial network. Each of the set of virtual receivers 576 on a reception path may comprise or constitute a demodulator (e.g., the OpenSpace™ Wideband Software Receiver) that converts incoming digital IF packets 571 containing digital IF waveforms into baseband frames 578 and an FEC decoder that receives the output of the demodulator and uses the redundant bits added by the FEC encoder to identify and correct any errors introduced during transmission. Baseband frames 578 produced by virtual receivers 576 are sent to the decapsulator of traffic adapter 572, which are then converted into Ethernet frames that are passed by the traffic handler to a terrestrial network.

Satellite 520 relays wireless signals from antenna 550 to the antennas of terminals 566, or vice versa. In two-way communications, satellite 520 also relays wireless signals from the antennas of terminals 566 to antenna 550. In some examples, each of terminals 566 may include hardware infrastructure to support one or more VNFs 555. In some examples, VNFs 555 at each of terminals 566 may implement a vModem that comprises one or more modulators that are configured to modulate waveforms according to a digital satellite broadcast standard and/or one or more demodulators that are configured to demodulate waveforms according to the digital satellite broadcast standard. Such a vModem may provide CE services, in which case the vModem may comprise one or more encapsulators that convert Ethernet frames into baseband frames that are modulated into waveforms by the modulator(s), and one or more decapsulators that convert baseband frames, which have been demodulated from waveforms by the demodulator(s), into Ethernet frames, together with a traffic handler that connects the encapsulators and decapsulators with the terrestrial networks connected to terminals 566.

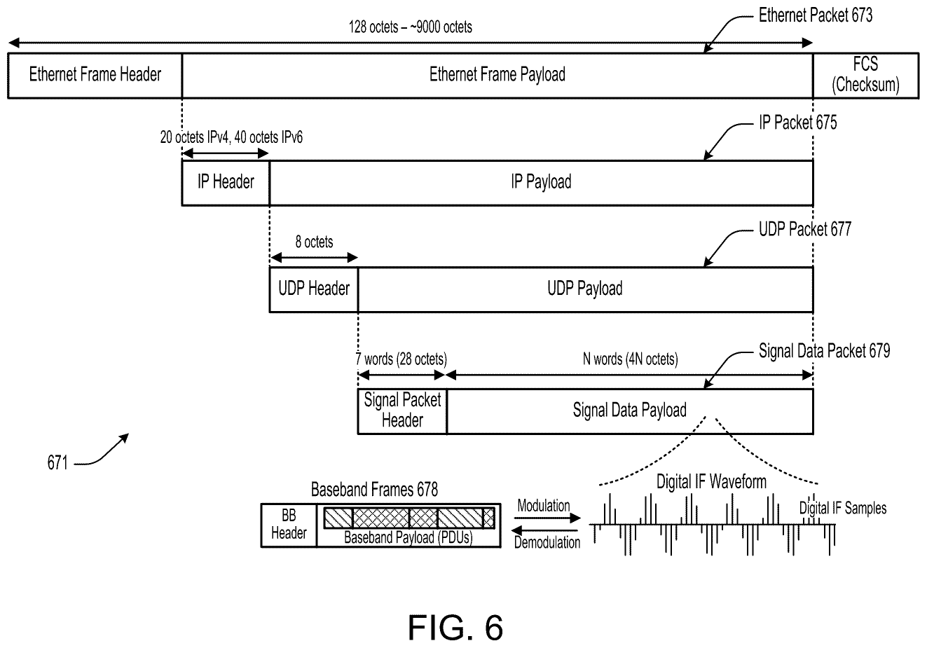

FIG. 6 illustrates an example digital IF packet 671 with multiple protocol layers, in accordance with some embodiments of the present disclosure. In the illustrated example, digital IF packet 671 includes a digital IF waveform contained within the signal data payload of a signal data packet 679. The digital IF waveform may represent the modulated form of one or more baseband frames 678 (or portions of one or more baseband frames 678), such that the baseband frames may be recovered by demodulating the digital IF waveform contained within the signal data payload. Signal data packet 679 may also include a signal packet header, which may implement the VITA standard (e.g., VITA 49.2 specification) or another standard.

In some examples, signal data packet 679 is encapsulated within a UDP packet 677 having a UDP header and UDP payload. UDP packet 677 may be encapsulated within an IP packet 675 having an IP header and IP payload, which may be encapsulated within an Ethernet packet 673 having an Ethernet frame header and Ethernet frame payload. In some examples, the total Ethernet packet size varies based on the number and size of the data samples in the signal data payload of signal data packet 679. There may be a fixed overhead within the Ethernet frame which comprises the IP header (20 octets for IPv4 or 40 octets (minimum) for IPv6), the UDP header (8 octets), the signal packet header (28 octets). In some examples, the Ethernet frame payload is adjustable from 128 octets to approximately 9000 octets.

In some examples, digital IF packet 671 may include different packet classes for signal data packet 679. In a first packet class, signal data packet 679 may be a regular data packet that includes the data for the digital samples forming the digital IF waveform. In a second packet class, signal data packet 679 may be a context packet that includes data to ensure standardization of the transport of metadata describing the sampled signal data. Such data may include the IF reference frequency, the sample rate, the bit depth, the equivalent analog bandwidth of the signal represented by the digital stream, the frequency offset of the center of the band occupied by the signal from the IF reference frequency, among other possibilities. In a third packet class, signal data packet 679 may be a command packet that includes data used to provide and acknowledge device settings and support control of timing to permit synchronization of upstream or downstream devices.

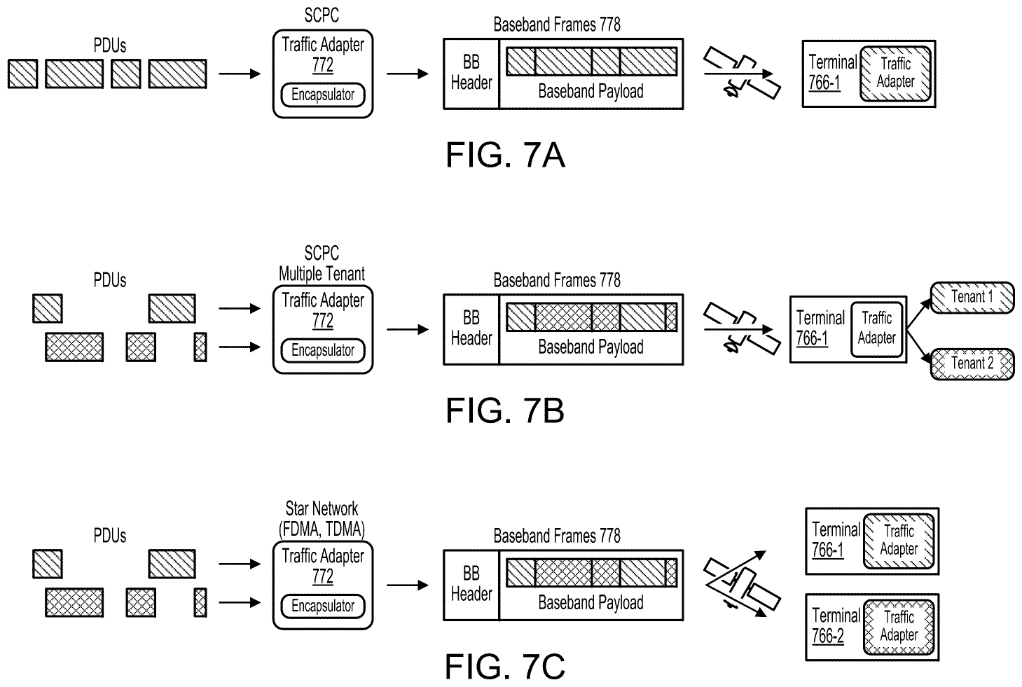

FIGS. 7A-7C illustrate example traffic adapters 772 implementing different network types, in accordance with some embodiments of the present disclosure. In FIG. 7A, traffic adapter 772 is configured by the management system to implement a SCPC (single tenant) network connection type. The encapsulator processes incoming PDUs destined for a terminal 766-1 by encapsulating the PDUs into a baseband frame 778 and adding an encapsulation header to each PDU and a baseband header to the entire baseband frame 778. The encapsulation headers (based on ETSI TS 102 606) include an identifier for terminal 766-1, an identifier of the encapsulated PDU's type, and an indicator of the length of the PDU. They may further include information to allow splitting an encapsulated PDU into multiple fragments to be distributed over multiple baseband frames 778. The baseband header includes, among other elements, information about the contained encapsulation structure and the total size of the payload. Upon receiving baseband frame 778, a traffic adapter of terminal 766-1 may decapsulate the baseband frame to recover the PDUs.

In FIG. 7B, traffic adapter 772 is configured by the management system to implement a SCPC (multiple tenant) network connection type. The encapsulator processes a first set of PDUs destined for Tenant 1 via terminal 766-1 and a second set of PDUs destined for Tenant 2 via terminal 766-1 by encapsulating both sets of PDUs (received within a particular time window) into a single baseband frame 778 and adding a baseband header to baseband frame 778 and individual encapsulation headers to each PDU. The encapsulation headers may include an identifier for Tenant 1, an identifier for Tenant 2, an indicator of the encapsulated PDU's content, an indicator of the size of the encapsulated PDU, and information about fragmentation of the encapsulated PDU across multiple baseband frames 778, among other possibilities. The baseband header includes, among other elements, information about the contained encapsulation structure and the total size of the payload. Upon receiving baseband frame 778, the traffic adapter of terminal 766-1 may decapsulate baseband frame 778 to recover and separate the PDUs, and may route the PDUs toward Tenant 1 and Tenant 2 as appropriate.

In FIG. 7C, traffic adapter 772 is configured by the management system to implement an FDMA or TDMA network connection type. The encapsulator processes a first set of PDUs destined for terminal 766-1 and a second set of PDUs destined for terminal 766-2 by encapsulating both sets of PDUs (received within a particular time window) into a single baseband frame 778 and adding a baseband header to baseband frame 778 and individual encapsulation headers to each PDU. The encapsulation headers include an identifier for terminal 366-1, an identifier for terminal 366-2, an indicator of the encapsulated PDU's content, an indicator of the size of the encapsulated PDU, and information about fragmentation of the encapsulated PDU across multiple baseband frames 778, among other possibilities. They may further include information to allow splitting an encapsulated PDU into multiple fragments to be distributed over multiple baseband frames 778. The baseband header includes, among other elements, information about the contained encapsulation structure and the total size of the payload. Upon receiving baseband frame 778, the traffic adapter of terminal 766-1 may decapsulate baseband frame 778 to recover the PDUs destined for terminal 766-1, and the traffic adapter of terminal 766-2 may decapsulate baseband frame 778 to recover the PDUs destined for terminal 766-2.

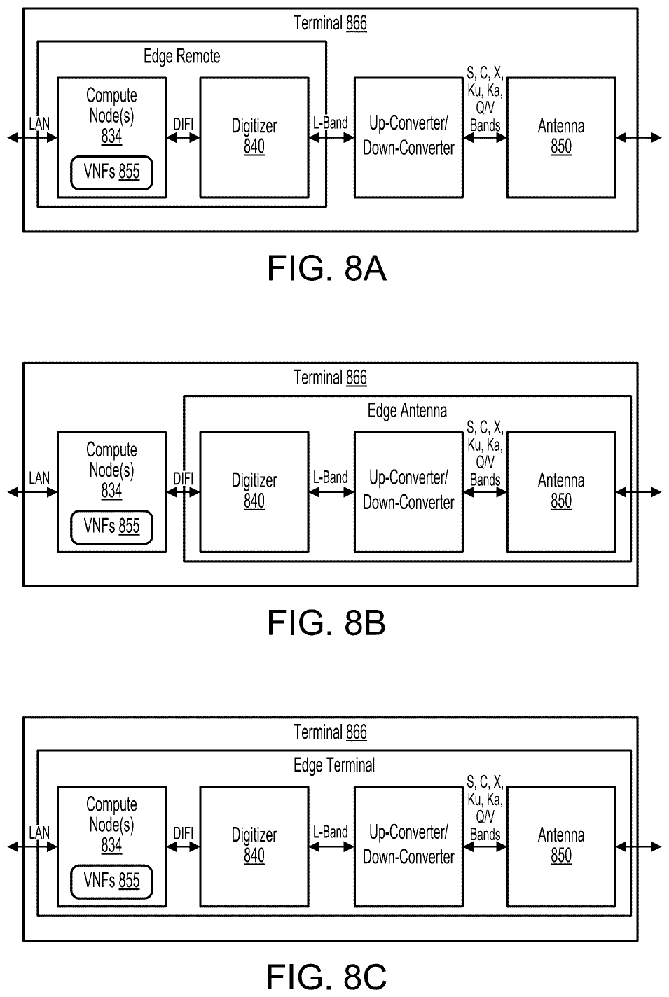

FIGS. 8A-8C illustrate example configurations of a terminal 866 having a digitizer 840, computes node(s) 834, and an antenna 850, in accordance with some embodiments of the present disclosure. In FIG. 8A, compute node(s) 834 (running one or more VNFs 855 including, e.g., a virtualized modem) and digitizer 840 are integrated together as an edge remote that is separate from the antenna/RF system. Digital IF packets may be sent between compute node(s) 834 and digitizer 840 via a PCIe bus. In the illustrated example, digitizer 840 sends/receives analog IF waveforms (within the L-band) to/from an up-converter or down-converter, which send/receive analog RF waveforms (within the S, C, X, Ku, Ka, Q/V bands) to/from antenna 850. This configuration allows digitizer 840 to be implemented within the compute infrastructure via a standard PCIe form factor for seamless add on of satellite access to an otherwise general-purpose piece of compute. In this example, compute node(s) 834 can be connected to antenna 850 via the added-on edge digitizer.

In FIG. 8B, digitizer 840, the up-converter or down-converter, and antenna 850 are integrated together as an edge antenna. In this example, the edge digitizer is integrated in the antenna and allows for transmission of digital IF waveforms via the ethernet/fiber interface on the antenna. Compute node(s) 834 can be connected with the edge antenna with an ethernet cable as in a typical IT network. This configuration has the advantage of the RF spectrum on the IP packets being transported from the antenna over IT infrastructure without the loss that may occur on coaxial or with RF over fiber.

In FIG. 8C, compute node(s) 834, digitizer 840, the up-converter or down-converter, and antenna 850 are implemented together as an edge terminal. This configuration makes a single piece of hardware possible but with the advantage of being able to change the mission or scale the number of modems without having to add more equipment.

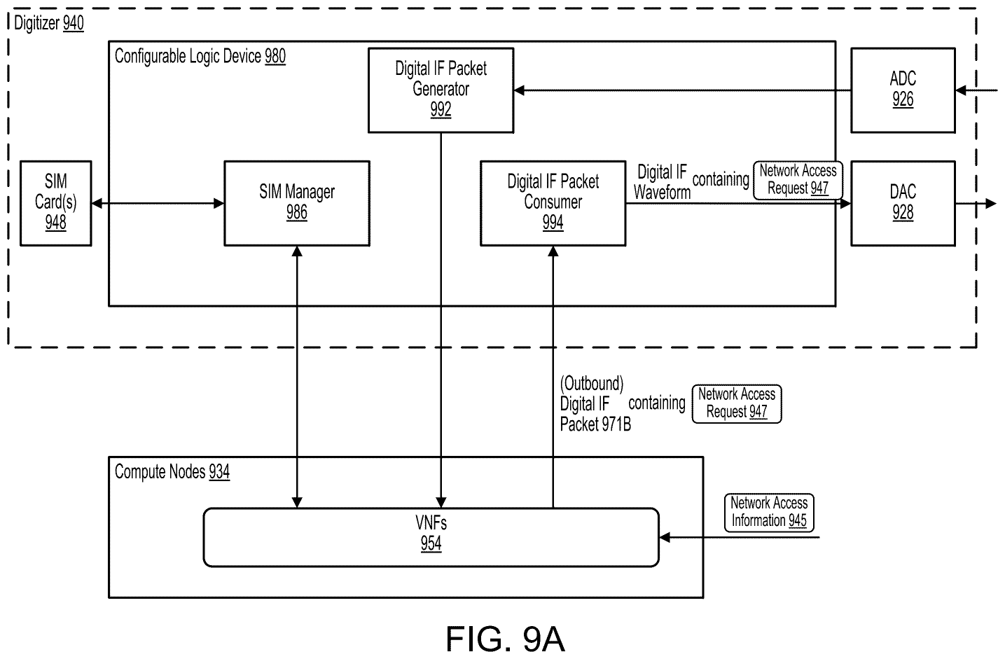

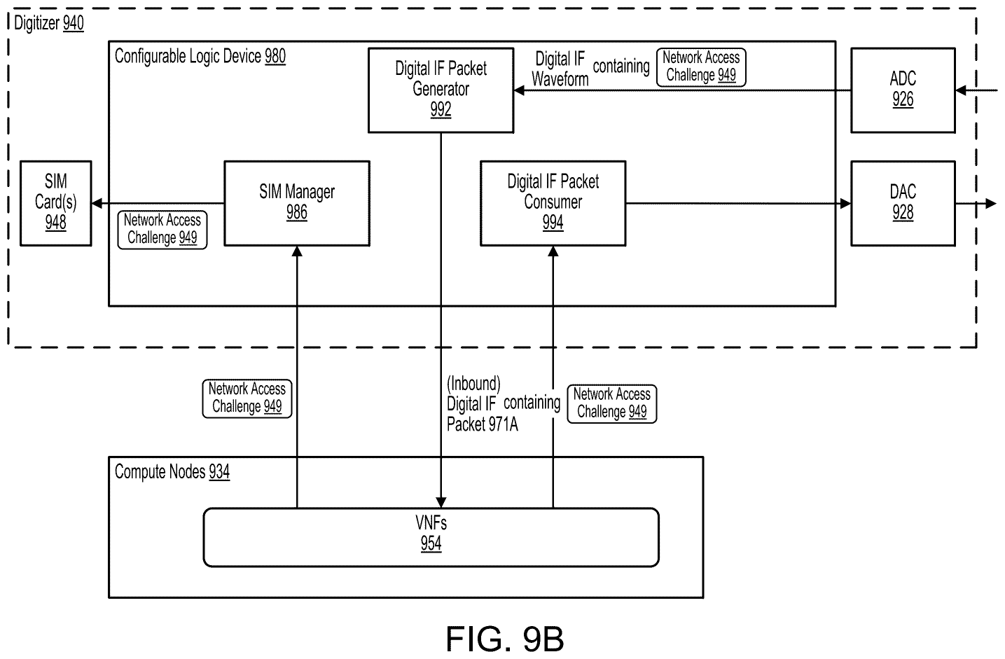

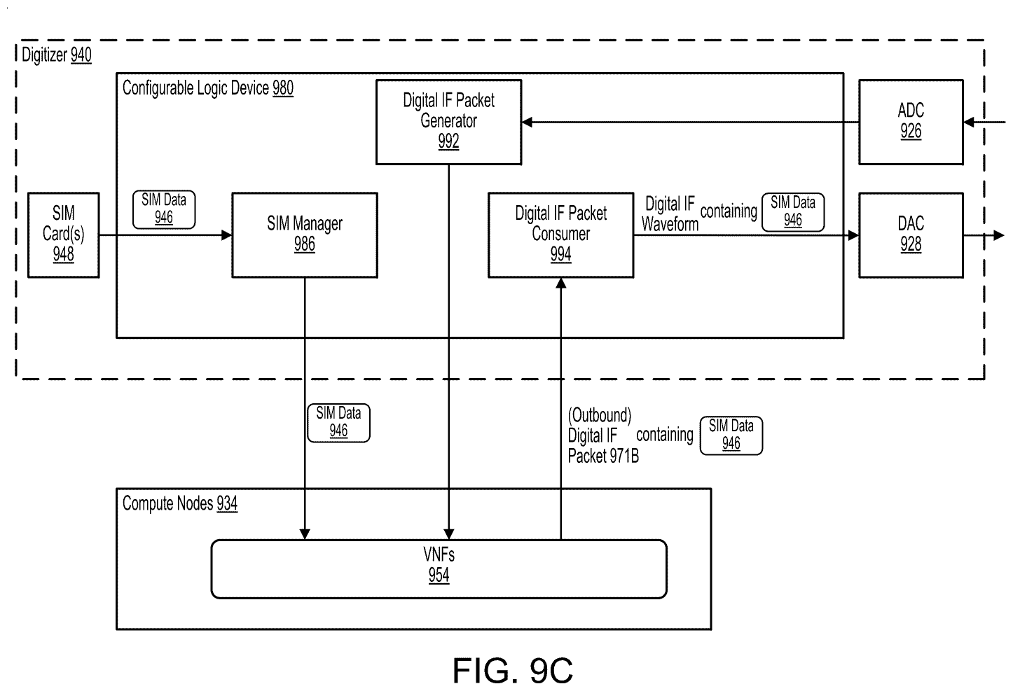

FIGS. 9A-9C illustrate example steps for using SIM data to access a non-terrestrial network, in accordance with some embodiments of the present disclosure. The example steps may be performed at a digitizer 940 and compute nodes 934 of a communication unit such as a remote terminal (e.g., UE) or ground station. The non-terrestrial network may be a 5G or 6G non-terrestrial network. In FIG. 9A, one or more VNFs 954 running on compute nodes 934 may obtain network access information 945 for the non-terrestrial network. Network access information 945 may include the name of the network, the locations of one or more satellites associated with the network, the frequency range for transmission and reception to/from the satellite(s), among other possibilities.

Further in FIG. 9A, after obtaining network access information 945, VNFs may send a network access request 947 to a satellite associated with the non-terrestrial network via digitizer 940. Network access request 947 may include an identifier for the communication unit, such as an IMSI, a SUPI, or a SUCI for the communication unit. VNFs 954 may generate an outbound digital IF packet 971B containing network access request 947. In some examples, VNFs 954 may insert network access request 947 into a baseband frame, modulate the baseband frame, and include the modulated baseband frame in outbound digital IF packet 971B. After being generated, outbound digital IF packet 971B is sent from VNFs 954 running on compute nodes 934 to a digital IF packet consumer 994 of configurable logic device 980, which extracts the digital IF waveform contained in outbound digital IF packets 971B and sends the digital IF waveform to a DAC 928 of digitizer 940. DAC 928 converts the digital IF waveform into an analog IF/RF signal for wireless transmission to the satellite associated with the non-terrestrial network.

In FIG. 9B, a network access challenge 949 is received by the communication unit from the satellite associated with the non-terrestrial network. Network access challenge 949 may include a random number and an authentication token. Digitizer 940 may receive an analog IF/RF signal from the communication unit's antenna that contains network access challenge 949. ADC 926 converts the analog IF/RF signal into a digital IF waveform and sends the digital IF waveform to a digital IF packet generator 992, which generates an inbound digital IF packet 271A based on the digital IF waveform. Digital IF packet generator 992 sends inbound digital IF packet 271A to VNFs 954 running on compute nodes 934. VNFs 954 extract network access challenge 949 from inbound digital IF packet 271A and send network access challenge 949 to SIM manager 986 or to SIM card 948 (optionally via SIM manager 986).

In FIG. 9C, either SIM card 948 (e.g., using the card's microprocessor) or SIM manager 986 uses data stored in SIM card 948 to generate SIM data 946 in response to network access challenge 949. SIM data 946 may include one or more of (1) a user/device identifier, such as an IMSI, a SUPI, or a SUCI for the communication unit, (2) an authentication response to network access challenge 949, or (3) device capability information. SIM card 948 or SIM manager 986 may use the random number from network access challenge 949 to generate the authentication response, and may use the authentication token from network access challenge 949 to verify that the challenge is legitimate. SIM card 948 or SIM manager 986 may use a secret key (K) (or “authentication key”) stored in SIM card 948 and a cryptographic algorithm to generate the authentication response based on the random number. The authentication key may be shared with the network.

Further in FIG. 9C, SIM manager 986 or SIM card 948 (optionally via SIM manager 986) may send SIM data 946 to VNFs 954 running on compute nodes 934. VNFs 954 may generate an outbound digital IF packet 971B (different from outbound digital IF packet 971B in FIG. 9A) containing SIM data 946. In some examples, VNFs 954 may insert SIM data 946 into a baseband frame, modulate the baseband frame, and include the modulated baseband frame (digital IF waveform) in outbound digital IF packet 971B. After being generated, outbound digital IF packet 971B is sent from VNFs 954 running on compute nodes 934 to digital IF packet consumer 994 of configurable logic device 980, which extracts the digital IF waveform contained in outbound digital IF packets 971B and sends the digital IF waveform to DAC 928. DAC 928 converts the digital IF waveform into an analog IF/RF signal. The communication unit's antenna is used to wirelessly transmit the analog IF/RF signal to the satellite associated with the non-terrestrial network. After successful authentication, the non-terrestrial network authorizes the communication unit (e.g., UE) to access specific services based on its subscription and policies. For example, the communication unit may send and receive data to/from other communication units that have also performed the authentication process.

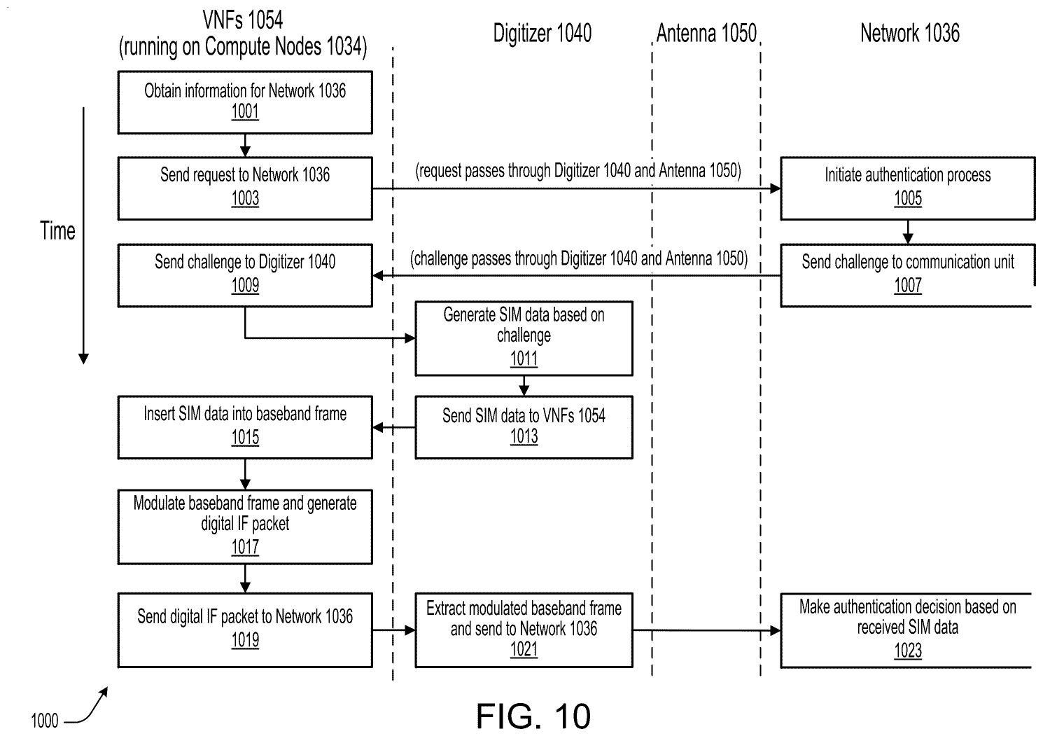

FIG. 10 illustrates an example network authentication process 1000 for a communication unit to access a non-terrestrial network 1036, in accordance with some embodiments of the present disclosure. The communication unit may be a remote terminal (e.g., UE) or ground station. Steps of network authentication process 1000 may performed by one or more VNFs 1054 running on compute nodes 1034 of the communication unit, a digitizer 1040 of the communication unit, an antenna 1050 of the communication unit, and non-terrestrial network 1036. At step 1001, VNFs 1054 obtain network access information for non-terrestrial network 1036. The network access information may include the name of non-terrestrial network 1036, the locations of one or more satellites associated with non-terrestrial network 1036, the frequency range for transmission and reception to/from the satellite(s), among other possibilities.

At step 1003, VNFs 1054 send a network access request to non-terrestrial network 1036 via digitizer 1040 and antenna 1050. The network access request may include an identifier for the communication unit, such as an IMSI, a SUPI, or a SUCI for the communication unit. At step 1005, non-terrestrial network 1036 initiates an authentication process. At step 1007, non-terrestrial network 1036 sends a network access challenge to VNFs 1054 via antenna 1050 and digitizer 1040. The network access challenge may include a random number and an authentication token. At step 1009, VNFs 1054 send the network access challenge to digitizer 1040. At step 1011, digitizer 1040 generates SIM data based on the network access challenge. The SIM data may include an authentication response to the network access challenge. Digitizer 1040 uses the authentication token from the network access challenge to verify that the challenge is legitimate and the random number from the network access challenge to generate the authentication response.

At step 1013, digitizer 1040 sends the SIM data to VNFs 1054. At step 1015, VNFs 1054 insert the SIM data into a baseband frame. At step 1017, VNFs modulate the baseband frame and generate a digital IF packet that contains the modulated baseband frame and the SIM data. At step 1019, VNFs 1054 send the digital IF packet to digitizer 1040. At step 1021, digitizer 1040 extracts the modulated baseband frame and sends the modulated baseband frame (containing the SIM data and the authentication response) to non-terrestrial network 1036 via antenna 1050. At step 1023, non-terrestrial network 1036 makes an authentication decision based on the SIM data. If non-terrestrial network 1036 decides to authenticate the communication unit, the communication unit may send and receive data to/from other communication units that have also been authenticated to communication on non-terrestrial network 1036.

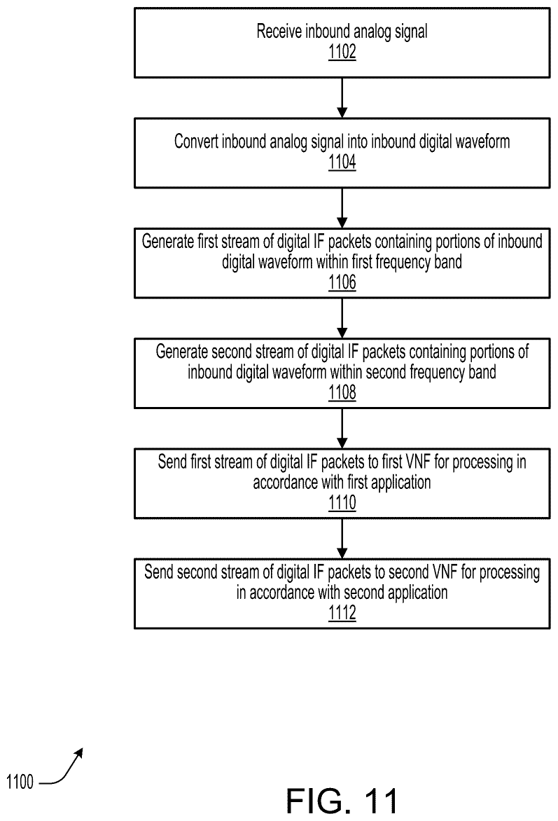

FIG. 11 illustrates a method 1100 of operating a digitizer, in accordance with some embodiments of the present disclosure. Steps of method 1100 may be performed in any order and/or in parallel, and one or more steps of method 1100 may be optionally performed. One or more steps of method 1100 may be performed by one or more processors. Method 1100 may be implemented as a computer-readable medium or computer program product comprising instructions which, when the program is executed by one or more processors, cause the one or more processors to carry out the steps of method 1100.

At step 1102, an inbound analog signal is received at a digitizer (e.g., digitizers 140, 340, 440, 540, 840, 940, 1040). The digitizer may be an element of a gateway (e.g., gateways 338, 438, 538) or a terminal (e.g., terminals 366, 466, 566, 766, 866). The inbound analog signal may be received at an input port (e.g., input port 164) of the digitizer. The inbound analog signal may have been generated by an antenna (e.g., antennas 350, 450, 550, 850, 1050) based on multiple wireless signals received by the antenna. The multiple wireless signals may have been transmitted by multiple satellites (e.g., satellites 320, 420, 520).

At step 1104, the inbound analog signal is converted into an inbound digital waveform by a radio interface (e.g., radio interface 132) of the digitizer. The radio interface may include a DAC (e.g., DACs 128, 228) for converting an outbound digital waveform into an outbound analog signal and an ADC (e.g., ADCs 126, 226) for converting the inbound analog signal into the inbound digital waveform. The inbound digital waveform may be sent from the radio interface to a configurable logic device (e.g., configurable logic devices 180, 280, 980) of the digitizer. The configurable logic device may be an FPGA.

At step 1106, a first stream of digital IF packets (e.g., digital IF packets 171, 271, 571, 671, 971) containing portions of the inbound digital waveform within a first frequency band is generated by the configurable logic device. The first frequency band may be specified by a configuration file (e.g., configuration files 185, 285) used to configure the configurable logic device.

At step 1108, a second stream of digital IF packets (e.g., digital IF packets 171, 271, 571, 671, 971) containing portions of the inbound digital waveform within a second frequency band is generated by the configurable logic device. The second frequency band may be specified by the configuration file. The second frequency band may be overlapping with, separate from, contained within, or completely encompass the first frequency band.

In some examples, the second stream of digital IF packets may be generated concurrently with the first stream of digital IF packets. For example, the configurable logic device may generate a first digital IF packet of the first stream at a first time, a first digital IF packet of the second stream at a second time after the first time, a second digital IF packet of the first stream at a third time after the second time, and a second digital IF packet of the second stream at a fourth time after the third time. In another example, the configurable logic device may generate the first digital IF packet of the first stream and the first digital IF packet of the second stream at the first time, and the second digital IF packet of the first stream and the second digital IF packet of the second stream at the second time.

At step 1110, the first stream of digital IF packets is sent from the configurable logic device to a first VNF (e.g., VNFs 355, 454, 455, 554, 555, 855, 954, 1054) for processing in accordance with a first application. The first stream of digital IF packets may be sent to one or more compute nodes (e.g., compute nodes 134, 434, 834, 934) on which the first VNF is run. The first stream of digital IF packets may be sent via a PCIe bus connecting the digitizer and the one or more compute nodes. The first application of the first VNF may be a satellite communications application or an EO mission download application.

At step 1112, the second stream of digital IF packets is sent from the configurable logic device to a second VNF (e.g., VNFs 355, 454, 455, 554, 555, 855) for processing in accordance with a second application. The second stream of digital IF packets may be sent to the one or more compute nodes on which the second VNF is run. The second stream of digital IF packets may be sent via the PCIe bus. The second application of the second VNF may be a RF monitoring application. In some examples, the second application is configured to, in response to determining that there is excessive RF interference in the first frequency band, generate a command to move the first frequency band to a new set of frequencies. Prior to generating the command, the second application may determine that there is low RF interference in the new set of frequencies.

In some examples, the second stream of digital IF packets may be sent concurrently with the first stream of digital IF packets. For example, the configurable logic device may send a first digital IF packet of the first stream at a first time, a first digital IF packet of the second stream at a second time after the first time, a second digital IF packet of the first stream at a third time after the second time, and a second digital IF packet of the second stream at a fourth time after the third time. In another example, the configurable logic device may send the first digital IF packet of the first stream and the second digital IF packet of the second stream at the first time, and the second digital IF packet of the first stream and the second digital IF packet of the second stream at the second time.

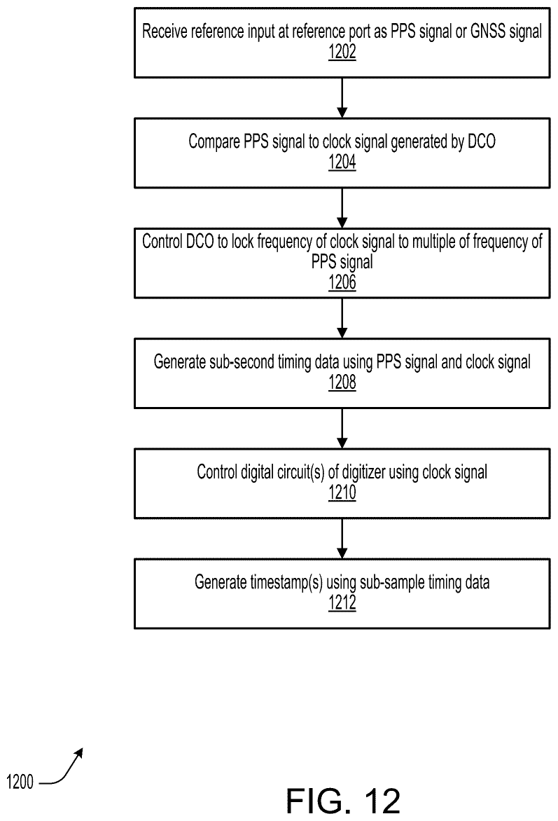

FIG. 12 illustrates a method 1200 of performing timing and frequency synchronization at a digitizer, in accordance with some embodiments of the present disclosure. Steps of method 1200 may be performed in any order and/or in parallel, and one or more steps of method 1200 may be optionally performed. One or more steps of method 1200 may be performed by one or more processors. Method 1200 may be implemented as a computer-readable medium or computer program product comprising instructions which, when the program is executed by one or more processors, cause the one or more processors to carry out the steps of method 1200.

At step 1202, a reference input (e.g., reference inputs 118, 218) is received at a reference port (e.g., reference port 170) of a digitizer (e.g., digitizers 140, 340, 440, 540, 840, 940, 1040). The digitizer may be an element of a gateway (e.g., gateways 338, 438, 538) or a terminal (e.g., terminals 366, 466, 566, 766, 866). The reference input may be a PPS signal or a GNSS signal from which the PPS signal is derived. In embodiments in which the reference input is the GNSS signal, a GNSS receiver (e.g., GNSS receiver 182) of the digitizer may extract the PPS signal from the GNSS input.

At step 1204, the PPS signal is compared to a clock signal (e.g., clock signals 174, 274) generated by a DCO (e.g., DCOs 184, 284). The PPS signal may be compared to the clock signal by a time delta accumulator (e.g., time delta accumulator 286) of the digitizer, which computes a time error (e.g., time error 216) based on the comparison.

At step 1206, the DCO is controlled to lock a frequency of the clock signal to a multiple of a frequency of the PPS signal. In some examples, the multiple may be 3×10⁷, 4×10⁷, or 5×10⁷, among other possibilities, such that the frequency of the clock signal may lock to 30 MHz, 40 MHz, or 50 MHz, respectively. The DCO may be controlled by a PID filter (e.g., PID filter 288) of the digitizer, which generates a LO control (e.g., LO control) to increase or decrease the frequency of the clock signal toward the multiple of the frequency of the PPS signal.

At step 1208, sub-second timing data (e.g., sub-second timing data 214) is generated using the PPS signal and the clock signal. The PPS signal may be used to compute a seconds component of the sub-second timing data. The clock signal may be used to compute a sub-second component of the sub-second timing data. The sub-second timing data may include a system time used for generating timestamps at the digitizer.

At step 1210, one or more digital circuits of the digitizer are controlled using the clock signal. Step 1210 may include providing the clock signal to an ADC (e.g., ADCs 126, 226) of the digitizer to control a sampling rate of the ADC. Step 1210 may include providing the clock signal to a DAC (e.g., DACs 128, 228) of the digitizer to control a sampling rate of the DAC.

At step 1212, one or more timestamps are generated at the digitizer using the sub-second timing data. The one or more timestamps may be inserted into a digital IF packet (e.g., digital IF packets 171, 271, 571, 671, 971). In some examples, an inbound analog signal is received at an input port (e.g., input port 164) of the digitizer. The inbound analog signal may have been generated by an antenna (e.g., antennas 350, 450, 550, 850, 1050) based on a wireless signal received by the antenna. The wireless signal may have been transmitted by a satellite (e.g., satellites 320, 420, 520). The inbound analog signal may be converted into an inbound digital waveform. The digital IF packet may be generated to contain the inbound digital waveform and the one or more timestamps. The digital IF packet may be generated by a digital IF packet generator (e.g., digital IF packet generator 292, 992) of a configurable logic device (e.g., configurable logic devices 180, 280, 980).

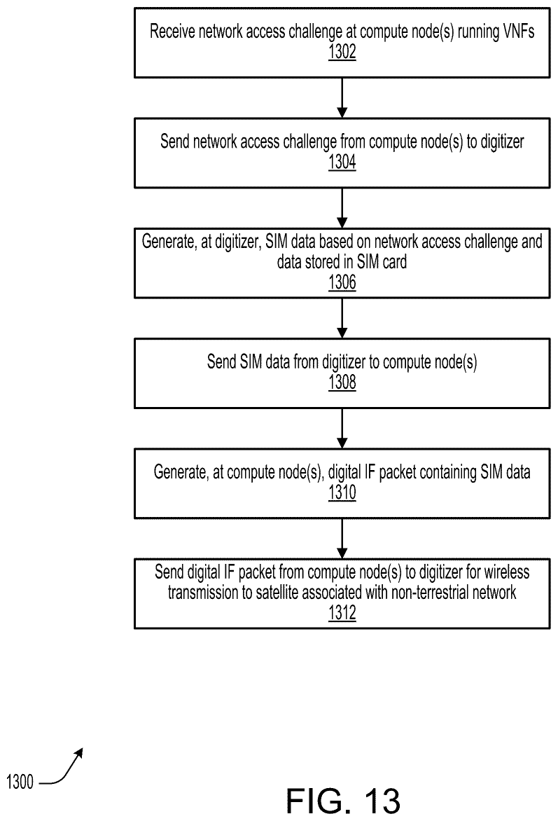

FIG. 13 illustrates a method 1300 of accessing a non-terrestrial network, in accordance with some embodiments of the present disclosure. Steps of method 1300 may be performed in any order and/or in parallel, and one or more steps of method 1300 may be optionally performed. One or more steps of method 1300 may be performed by one or more processors. Method 1300 may be implemented as a computer-readable medium or computer program product comprising instructions which, when the program is executed by one or more processors, cause the one or more processors to carry out the steps of method 1300.

At step 1302, a network access challenge (e.g., network access challenge 149, 249, 949) is received at one or more compute nodes (e.g., compute nodes 134, 434, 834, 934) of a terminal (e.g., terminals 366, 466, 566, 766, 866). The one or more compute nodes may be running one or more VNFs (e.g., VNFs 355, 454, 455, 554, 555, 855, 954, 1054). The network access challenge may be received from a non-terrestrial network (e.g., non-terrestrial network 1036).

At step 1304, the network access challenge is sent from the one or more compute nodes to a digitizer (e.g., digitizers 140, 340, 440, 540, 840, 940, 1040) of the terminal. The digitizer may include a SIM card (e.g., SIM cards 148, 248, 948). The digitizer may include a radio interface (e.g., radio interface 132). The radio interface may include a DAC (e.g., DACs 128, 228) for converting an outbound digital waveform into an outbound analog signal and an ADC (e.g., ADCs 126, 226) for converting an inbound analog signal into an inbound digital waveform. The digitizer may include a configurable logic device (e.g., configurable logic devices 180, 280, 980). The configurable logic device may be an FPGA.

At step 1306, SIM data (e.g., SIM data 146, 246, 946) may be generated based on the network access challenge and data stored in the SIM card. The SIM data may be generated at the digitizer. The SIM data may include an authentication response to the network access challenge.

At step 1308, the SIM data is sent from the digitizer to the one more compute nodes.

At step 1310, a digital IF packet (e.g., digital IF packets 171, 271, 571, 671, 971) containing the SIM data is generated. The digital IF packet may be generated at the one or more compute nodes. The SIM data may be inserted into a baseband frame (e.g., baseband frames 578, 678, 778). The baseband frame may be modulated, producing a modulated baseband frame. The digital IF packet may be generated to contain the modulated baseband frame.

At step 1312, the digital IF packet is sent from the one more compute nodes to the digitizer for wireless transmission of the SIM data to a satellite (e.g., satellites 320, 420, 520) associated with the non-terrestrial network.

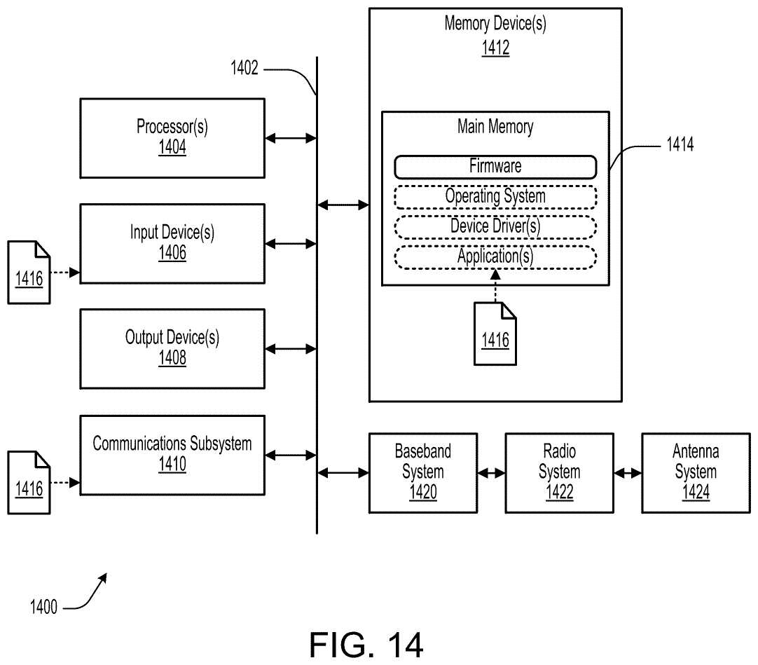

FIG. 14 illustrates an example computer system 1400 comprising various hardware elements, in accordance with some embodiments of the present disclosure. Computer system 1400 may be incorporated into or integrated with devices described herein and/or may be configured to perform some or all of the steps of the methods provided by various embodiments. It should be noted that FIG. 14 is meant only to provide a generalized illustration of various components, any or all of which may be utilized as appropriate. FIG. 14, therefore, broadly illustrates how individual system elements may be implemented in a relatively separated or relatively more integrated manner.

In the illustrated example, computer system 1400 includes a communication medium 1402, one or more processor(s) 1404, one or more input device(s) 1406, one or more output device(s) 1408, a communications subsystem 1410, one or more memory device(s) 1412, a baseband system 1420, a radio system 1422, and an antenna system 1424. Computer system 1400 may be implemented using various hardware implementations and embedded system technologies. For example, one or more elements of computer system 1400 may be implemented within an integrated circuit (IC), an application-specific integrated circuit (ASIC), an application-specific standard product (ASSP), a field-programmable gate array (FPGA), such as those commercially available by XILINX®, INTEL®, or LATTICE SEMICONDUCTOR®, a system-on-a-chip (SoC), a microcontroller, a printed circuit board (PCB), and/or a hybrid device, such as an SoC FPGA, among other possibilities.

The various hardware elements of computer system 1400 may be communicatively coupled via communication medium 1402. While communication medium 1402 is illustrated as a single connection for purposes of clarity, it should be understood that communication medium 1402 may include various numbers and types of communication media for transferring data between hardware elements. For example, communication medium 1402 may include one or more wires (e.g., conductive traces, paths, or leads on a PCB or integrated circuit (IC), microstrips, striplines, coaxial cables), one or more optical waveguides (e.g., optical fibers, strip waveguides), and/or one or more wireless connections or links (e.g., infrared wireless communication, radio communication, microwave wireless communication), among other possibilities.

In some embodiments, communication medium 1402 may include one or more buses that connect the pins of the hardware elements of computer system 1400. For example, communication medium 1402 may include a bus that connects processor(s) 1404 with main memory 1414, referred to as a system bus, and a bus that connects main memory 1414 with input device(s) 1406 or output device(s) 1408, referred to as an expansion bus. The system bus may itself consist of several buses, including an address bus, a data bus, and a control bus. The address bus may carry a memory address from processor(s) 1404 to the address bus circuitry associated with main memory 1414 in order for the data bus to access and carry the data contained at the memory address back to processor(s) 1404. The control bus may carry commands from processor(s) 1404 and return status signals from main memory 1414. Each bus may include multiple wires for carrying multiple bits of information and each bus may support serial or parallel transmission of data.

Processor(s) 1404 may include one or more central processing units (CPUs), graphics processing units (GPUs), neural network processors or accelerators, digital signal processors (DSPs), and/or other general-purpose or special-purpose processors capable of executing instructions. A CPU may take the form of a microprocessor, which may be fabricated on a single IC chip of metal-oxide-semiconductor field-effect transistor (MOSFET) construction. Processor(s) 1404 may include one or more multi-core processors, in which each core may read and execute program instructions concurrently with the other cores, increasing speed for programs that support multithreading.

Input device(s) 1406 may include one or more of various user input devices such as a mouse, a keyboard, a microphone, as well as various sensor input devices, such as an image capture device, a temperature sensor (e.g., thermometer, thermocouple, thermistor), a pressure sensor (e.g., barometer, tactile sensor), a movement sensor (e.g., accelerometer, gyroscope, tilt sensor), a light sensor (e.g., photodiode, photodetector, charge-coupled device), and/or the like. Input device(s) 1406 may also include devices for reading and/or receiving removable storage devices or other removable media. Such removable media may include optical discs (e.g., Blu-ray discs, DVDs, CDs), memory cards (e.g., CompactFlash card, Secure Digital (SD) card, Memory Stick), floppy disks, Universal Serial Bus (USB) flash drives, external hard disk drives (HDDs) or solid-state drives (SSDs), and/or the like.

Output device(s) 1408 may include one or more of various devices that convert information into human-readable form, such as without limitation a display device, a speaker, a printer, a haptic or tactile device, and/or the like. Output device(s) 1408 may also include devices for writing to removable storage devices or other removable media, such as those described in reference to input device(s) 1406. Output device(s) 1408 may also include various actuators for causing physical movement of one or more components. Such actuators may be hydraulic, pneumatic, electric, and may be controlled using control signals generated by computer system 1400.

Communications subsystem 1410 may include hardware components for connecting computer system 1400 to systems or devices that are located external to computer system 1400, such as over a computer network. In various embodiments, communications subsystem 1410 may include a wired communication device coupled to one or more input/output ports (e.g., a universal asynchronous receiver-transmitter (UART)), an optical communication device (e.g., an optical modem), an infrared communication device, a radio communication device (e.g., a wireless network interface controller, a BLUETOOTH® device, an IEEE 802.11 device, a Wi-Fi device, a Wi-Max device, a cellular device), among other possibilities.

Memory device(s) 1412 may include the various data storage devices of computer system 1400. For example, memory device(s) 1412 may include various types of computer memory with various response times and capacities, from faster response times and lower capacity memory, such as processor registers and caches (e.g., L0, L1, L2), to medium response time and medium capacity memory, such as random-access memory (RAM), to lower response times and lower capacity memory, such as solid-state drives and hard drive disks. While processor(s) 1404 and memory device(s) 1412 are illustrated as being separate elements, it should be understood that processor(s) 1404 may include varying levels of on-processor memory, such as processor registers and caches that may be utilized by a single processor or shared between multiple processors.

Memory device(s) 1412 may include main memory 1414, which may be directly accessible by processor(s) 1404 via the address and data buses of communication medium 1402. For example, processor(s) 1404 may continuously read and execute instructions stored in main memory 1414. As such, various software elements may be loaded into main memory 1414 to be read and executed by processor(s) 1404 as illustrated in FIG. 14. Typically, main memory 1414 is volatile memory, which loses all data when power is turned off and accordingly needs power to preserve stored data. Main memory 1414 may further include a small portion of non-volatile memory containing software (e.g., firmware, such as BIOS) that is used for reading other software stored in memory device(s) 1412 into main memory 1414. In some embodiments, the volatile memory of main memory 1414 is implemented as RAM, such as dynamic random-access memory (DRAM), and the non-volatile memory of main memory 1414 is implemented as read-only memory (ROM), such as flash memory, erasable programmable read-only memory (EPROM), or electrically erasable programmable read-only memory (EEPROM).

Computer system 1400 may include software elements, shown as being currently located within main memory 1414, which may include an operating system, device driver(s), firmware, compilers, and/or other code, such as one or more application programs, which may include computer programs provided by various embodiments of the present disclosure. Merely by way of example, one or more steps described with respect to any methods discussed above, may be implemented as instructions 1416, which are executable by computer system 1400. In one example, such instructions 1416 may be received by computer system 1400 using communications subsystem 1410 (e.g., via a wireless or wired signal that carries instructions 1416), carried by communication medium 1402 to memory device(s) 1412, stored within memory device(s) 1412, read into main memory 1414, and executed by processor(s) 1404 to perform one or more steps of the described methods. In another example, instructions 1416 may be received by computer system 1400 using input device(s) 1406 (e.g., via a reader for removable media), carried by communication medium 1402 to memory device(s) 1412, stored within memory device(s) 1412, read into main memory 1414, and executed by processor(s) 1404 to perform one or more steps of the described methods.

Computer system 1400 may include optional wireless communication components that facilitate wireless communication over a voice network and/or a data network. The wireless communication components comprise an antenna system 1424, a radio system 1422, and a baseband system 1420. In computer system 1400, RF signals are transmitted and received over the air by antenna system 1424 under the management of radio system 1422. In an embodiment, antenna system 1424 may comprise one or more antennae and one or more multiplexors (not shown) that perform a switching function to provide antenna system 1424 with transmit and receive signal paths. In the reception path, received RF signals can be coupled from a multiplexor to a low noise amplifier (not shown) that amplifies the received RF signal and sends the amplified signal to radio system 1422. In an alternative embodiment, radio system 1422 may comprise one or more radios that are configured to communicate over various frequencies. In an embodiment, radio system 1422 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 1422 to baseband system 1420.

In some embodiments of the present disclosure, instructions 1416 are stored on a computer-readable storage medium (or simply computer-readable medium). Such a computer-readable medium may be non-transitory and may therefore be referred to as a non-transitory computer-readable medium. In some cases, the non-transitory computer-readable medium may be incorporated within computer system 1400. For example, the non-transitory computer-readable medium may be one of memory device(s) 1412 (as shown in FIG. 14). In some cases, the non-transitory computer-readable medium may be separate from computer system 1400. In one example, the non-transitory computer-readable medium may be a removable medium provided to input device(s) 1406 (as shown in FIG. 14), such as those described in reference to input device(s) 1406, with instructions 1416 being read into computer system 1400 by input device(s) 1406. In another example, the non-transitory computer-readable medium may be a component of a remote electronic device, such as a mobile phone, that may wirelessly transmit a data signal that carries instructions 1416 to computer system 1400 and that is received by communications subsystem 1410 (as shown in FIG. 14).

Instructions 1416 may take any suitable form to be read and/or executed by computer system 1400. For example, instructions 1416 may be source code (written in a human-readable programming language such as Java, C, C++, C#, Python), object code, assembly language, machine code, microcode, executable code, and/or the like. In one example, instructions 1416 are provided to computer system 1400 in the form of source code, and a compiler is used to translate instructions 1416 from source code to machine code, which may then be read into main memory 1414 for execution by processor(s) 1404. As another example, instructions 1416 are provided to computer system 1400 in the form of an executable file with machine code that may immediately be read into main memory 1414 for execution by processor(s) 1404. In various examples, instructions 1416 may be provided to computer system 1400 in encrypted or unencrypted form, compressed or uncompressed form, as an installation package or an initialization for a broader software deployment, among other possibilities.

In one aspect of the present disclosure, a system (e.g., computer system 1400) is provided to perform methods in accordance with various embodiments of the present disclosure. For example, some embodiments may include a system comprising one or more processors (e.g., processor(s) 1404) that are communicatively coupled to a non-transitory computer-readable medium (e.g., memory device(s) 1412 or main memory 1414). The non-transitory computer-readable medium may have instructions (e.g., instructions 1416) stored therein that, when executed by the one or more processors, cause the one or more processors to perform the methods described in the various embodiments.

In another aspect of the present disclosure, a computer-program product that includes instructions (e.g., instructions 1416) is provided to perform methods in accordance with various embodiments of the present disclosure. The computer-program product may be tangibly embodied in a non-transitory computer-readable medium (e.g., memory device(s) 1412 or main memory 1414). The instructions may be configured to cause one or more processors (e.g., processor(s) 1404) to perform the methods described in the various embodiments.

In another aspect of the present disclosure, a non-transitory computer-readable medium (e.g., memory device(s) 1412 or main memory 1414) is provided. The non-transitory computer-readable medium may have instructions (e.g., instructions 1416) stored therein that, when executed by one or more processors (e.g., processor(s) 1404), cause the one or more processors to perform the methods described in the various embodiments.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes reference to one or more of such users, and reference to “a processor” includes reference to one or more processors and equivalents thereof known to those skilled in the art, and so forth.

Also, the words “comprise,” “comprising,” “contains,” “containing,” “include,” “including,” and “includes,” when used in this specification and in the following claims, are intended to specify the presence of stated features, integers, components, or steps, but they do not preclude the presence or addition of one or more other features, integers, components, steps, acts, or groups.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An apparatus comprising:
a radio interface comprising a digital-to-analog converter (DAC) for converting an outbound digital waveform into an outbound analog signal and an analog-to-digital converter (ADC) for converting an inbound analog signal into an inbound digital waveform; and
a configurable logic device coupled with the radio interface, the configurable logic device configured to:
respectively send and receive the outbound digital waveform and the inbound digital waveform to and from the radio interface;
generate a first stream of digital IF packets containing portions of the inbound digital waveform within a first frequency band;
generate a second stream of digital IF packets containing portions of the inbound digital waveform within a second frequency band;
send the first stream of digital IF packets to a first virtual network function (VNF) for processing in accordance with a first application; and
send the second stream of digital IF packets to a second VNF for processing in accordance with a second application.

2. The apparatus of claim 1, wherein the second stream of digital IF packets is sent concurrently with the first stream of digital IF packets.

3. The apparatus of claim 1, wherein the configurable logic device is a field-programmable gate array (FPGA).

4. The apparatus of claim 1, further comprising:
an input port for receiving the inbound analog signal; and
an output port for sending the outbound analog signal.

5. The apparatus of claim 1, wherein the configurable logic device is further configured to:
be configured in accordance with a configuration file generated by a management system, wherein the configuration file indicates the first frequency band and the second frequency band.

6. The apparatus of claim 1, wherein the first stream of digital IF packets and the second stream of digital IF packets are sent to one or more compute nodes on which the first VNF and the second VNF are run.

7. The apparatus of claim 6, wherein the first stream of digital IF packets and the second stream of digital IF packets are sent to the one or more compute nodes via a Peripheral Component Interconnect Express (PCIe) bus.

8. The apparatus of claim 1, wherein the first application of the first VNF is a satellite communications application or an Earth orbit (EO) mission download application.

9. The apparatus of claim 8, wherein the second application of the second VNF is a radio-frequency (RF) monitoring application, and wherein the second frequency band encompasses the first frequency band.

10. The apparatus of claim 9, wherein the second application is configured to, in response to determining that there is excessive RF interference in the first frequency band, generate a command to move the first frequency band to a new set of frequencies.

11. A method comprising:
receiving an inbound analog signal at an apparatus;
converting, by a radio interface of the apparatus, the inbound analog signal into an inbound digital waveform;
generating, by a configurable logic device of the apparatus, a first stream of digital IF packets containing portions of the inbound digital waveform within a first frequency band;
generating, by the configurable logic device, a second stream of digital IF packets containing portions of the inbound digital waveform within a second frequency band;
sending, by the configurable logic device, the first stream of digital IF packets to a first virtual network function (VNF) for processing in accordance with a first application; and
sending, by the configurable logic device, the second stream of digital IF packets to a second VNF for processing in accordance with a second application.

12. The method of claim 11, wherein the second stream of digital IF packets is sent concurrently with the first stream of digital IF packets.

13. The method of claim 11, wherein the configurable logic device is a field-programmable gate array (FPGA).

14. The method of claim 11, wherein the first stream of digital IF packets and the second stream of digital IF packets are sent to one or more compute nodes on which the first VNF and the second VNF are run.

15. The method of claim 14, wherein the first stream of digital IF packets and the second stream of digital IF packets are sent to the one or more compute nodes via a Peripheral Component Interconnect Express (PCIe) bus.

16. The method of claim 11, wherein the first application of the first VNF is a satellite communications application or an Earth orbit (EO) mission download application.

17. The method of claim 16, wherein the second application of the second VNF is a radio-frequency (RF) monitoring application, and wherein the second frequency band encompasses the first frequency band.

18. The method of claim 17, wherein the second application is configured to, in response to determining that there is excessive RF interference in the first frequency band, generate a command to move the first frequency band to a new set of frequencies.

19. A non-transitory computer-readable medium comprising instructions that, when executed by one or more processors, cause the one or more processors to perform operations for operating a digitizer, the operations comprising:
receiving an inbound digital waveform at a configurable logic device of the digitizer, the inbound digital waveform having been converted from an inbound analog signal by a radio interface of the digitizer;
generating, by the configurable logic device, a first stream of digital IF packets containing portions of the inbound digital waveform within a first frequency band;
generating, by the configurable logic device, a second stream of digital IF packets containing portions of the inbound digital waveform within a second frequency band;
sending, by the configurable logic device, the first stream of digital IF packets to a first virtual network function (VNF) for processing in accordance with a first application; and
sending, by the configurable logic device, the second stream of digital IF packets to a second VNF for processing in accordance with a second application.

20. The non-transitory computer-readable medium of claim 19, wherein the second stream of digital IF packets is sent concurrently with the first stream of digital IF packets.
